(19) United States
(12) Patent Application Publication
(10) Pub. No.: US 2016/0219545 A1
(43) Pub. Date: Jul. 28, 2016

(54) METHOD AND SYSTEM FOR FEEDING BACK UPLINK HYBRID AUTOMATIC REPEAT REQUEST, AND RELATED DEVICE

(71) Applicant: Huawei Technologies Co., Ltd., Shenzhen (CN)

(72) Inventors: Jinfang ZHANG, Shenzhen (CN); Bojie LI, Shenzhen (CN)

(21) Appl. No.: 15/093,268

(22) Filed: Apr. 7, 2016

Related U.S. Application Data
(63) Continuation of application No. PCT/CN2013/086854, filed on Nov. 11, 2013.

(51) Int. Cl. H04W 56/00; H04L 29/08; H04L 5/00; H04L 5/14; H04L 1/18; H04W 72/04

(52) U.S. Cl. CPC H04W 56/006; H04L 1/1812; H04W 72/0413; H04W 72/042; H04L 5/0055; H04L 5/14; H04L 29/08018; H04L 1/1854; H04W 88/085

(57) ABSTRACT

A feedback method and system for an uplink hybrid automatic repeat request, and a related device are provided. The method comprises: determining a first transmission and processing time period, wherein the first transmission and processing time period comprises a transmission and processing time period from a time when uplink data is received by a remote radio unit (RRU) to a time when the RRU sends feedback information of the uplink data; and sending, in a case that the first transmission and processing time period is longer than a predetermined feedback delay and before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

### CROSS-REFERENCE TO RELATED APPLICATIONS

This application is a continuation of International Patent Application No. PCT/CN2013/086854, filed on Nov. 11, 2013, which is hereby incorporated by reference in its entirety.

### TECHNICAL FIELD

The present disclosure relates to the technical field of communications, and in particular to a feedback method and feedback system for an uplink hybrid automatic repeat request and a related device.

### BACKGROUND

Presently, a radio access network system based on the cloud computing technology, C-RAN (Cloud-Radio Access Network) draws wide attention from the industry. FIG. 1A and FIG. 1B show two types of typical C-RAN network architectures. In the above network architectures, uplink data and downlink ACK/NACK (acknowledge/non-acknowledge) feedback each are transmitted through a transport network, which may cause extra transmission delay influencing a feedback point in time.

In the conventional technology, for FDD (Frequency Division Duplex) or TDD (Time Division Duplex) in an LTE system, ACK/NACK feedback, which indicates whether a transmission is performed correctly, is provided in a fixed subframe, i.e., ACK/NACK in a k-th subframe is the feedback for data transmitted in a (k−n)-th subframe. In an LTE FDD system, n is a constant, i.e. 4. In a TDD system, the value of n varies depending on different uplink/downlink configurations.

There are some solutions for processing an HARQ feedback delay in the conventional technology; however, in a case that a transmission time period or a processing time period is long, the feedback time instant is later than that stipulated in the conventional protocol, and thereby increasing HARQ RTT (Round trip time) and influencing the service performance.

### SUMMARY

According to embodiments of the present disclosure, a feedback method and feedback system for an uplink hybrid automatic repeat request and a related device are provided, so as to address a technical issue that uplink HARQ RTT is increased in a case that a transmission time period or a processing time period is long.

According to a first aspect of the present disclosure, a centralized computation center is provided, which includes:

a first determining unit configured to determine a first transmission and processing time period, where the first transmission and processing time period includes a transmission and processing time period from a time when uplink data is received by a remote radio unit RRU to a time when the RRU sends feedback information of the uplink data; and

a first sending unit configured to send, in a case that the first transmission and processing time period is longer than a predetermined feedback delay and before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

In a first possible implementation, the first sending unit may be further configured to send first instruction information to the RRU, which in turn sends the first instruction information to the user terminal; where the first instruction information is used to instruct the user terminal to start physical layer processing on data to be retransmitted and/or new data at a predetermined time.

In conjunction with the first aspect or the first possible implementation of the first aspect, in a second possible implementation, the centralized computation center may further include:

a second determining unit configured to determine a second transmission and processing time period, where the second transmission and processing time period includes a transmission and processing time period from a time when the centralized computation center starts to send downlink subframe data to a time when the RRU sends the downlink subframe data, or the second transmission and processing time period includes a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data,

where the first sending unit is configured to send the virtual feedback information of the uplink data and/or the scheduling information of the uplink data to the RRU n1 subframes in advance, where a time duration of the n1 subframes is longer than or equal to the second transmission and processing time period.

In conjunction with the second possible implementation of the first aspect, in a third possible implementation, the first sending unit may be further configured to send true feedback information of the uplink data to the RRU, which in turn sends the true feedback information to the user terminal.

In conjunction with the third possible implementation of the first aspect, in a fourth possible implementation, the centralized computation center may further include:

an off-line planning unit configured to determine the first transmission and processing time period and/or the second transmission and processing time period by planning in an off-line manner; or

a real-time measuring unit configured to determine the first transmission and processing time period and/or the second transmission and processing time period by measuring in a real time manner.

According to a second aspect of the present disclosure, a remote radio unit is provided, which includes:

a first receiving unit configured to receive virtual feedback information of uplink data and/or scheduling information of the uplink data sent by a centralized computation center or a local computation center, where the virtual feedback information of the uplink data and/or the scheduling information of the uplink data is sent, in a case that a first transmission and processing time period is longer than a predetermined feedback delay and before a decoding result of the uplink data is obtained, to the remote radio unit RRU by the centralized computation center or the local computation center, and the first transmission and processing time period includes a transmission and processing time period from a time when the uplink data is received by the RRU to a time when the RRU sends feedback information of the uplink data; and

a second sending unit configured to send the virtual feedback information of the uplink data and/or the scheduling information of the uplink data to a user terminal in a predetermined subframe.

According to a third aspect, a local computation center is provided, which includes:

a second receiving unit configured to receive second instruction information for instructing to perform virtual feedback on uplink data and/or scheduling information of the uplink data sent by a centralized computation center, where the second instruction information is sent to the local computation center by the centralized computation center in a case that a first transmission and processing time period is longer than a predetermined feedback delay; and the first transmission and processing time period includes a transmission and processing time period from a time when the uplink data is received by the RRU to a time when the RRU sends feedback information of the uplink data; and

a third sending unit configured to send, before a decoding result of the uplink data is obtained, virtual feedback information of the uplink data and/or the scheduling information of the uplink data to the RRU, which in turn sends the virtual feedback information of the uplink data and/or the scheduling information of the uplink data to a user terminal in a predetermined subframe.

According to a fourth aspect of the present disclosure, a user terminal is provided, which includes:

a third receiving unit configured to receive virtual feedback information of uplink data and/or scheduling information of the uplink data sent by a remote radio unit RRU in a predetermined subframe, where the virtual feedback information of the uplink data and/or the scheduling information of the uplink data is sent, in a case that a first transmission and processing time period is longer than a predetermined feedback delay and before a decoding result of the uplink data is obtained, to the RRU by a centralized computation center or a local computation center; and the first transmission and processing time period includes a transmission and processing time period from a time when the uplink data is received by the RRU to a time when the RRU sends feedback information of the uplink data; and

a processing unit configured to start, based on the virtual feedback information of the uplink data and/or the scheduling information of the uplink data, physical layer processing on data to be retransmitted and/or new data at a predetermined time.

According to a fifth aspect of the present disclosure, a feedback system for an uplink hybrid automatic repeat request is provided, which includes the centralized computation center according to the first aspect of the present disclosure, and the remote radio unit according to the second aspect of the present disclosure, and/or the local computation center according to the third aspect of the present disclosure, and/or the user terminal according to the fourth aspect of the present disclosure.

According to a sixth aspect of the present disclosure, a feedback method for an uplink hybrid automatic repeat request is provided, which includes:

determining a first transmission and processing time period, where the first transmission and processing time period includes a transmission and processing time period from a time when uplink data is received by a remote radio unit RRU to a time when the RRU sends feedback information of the uplink data; and

sending, in a case that first transmission and processing time period is longer than a predetermined feedback delay and before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

In a first possible implementation, before the sending virtual feedback information of the uplink data and/or scheduling information of the uplink data to the RRU, the method may further include:

sending first instruction information to the RRU, which in turn sends the first instruction information to the user terminal, where the first instruction information is used to instruct the user terminal to start physical layer processing on data to be retransmitted and/or new data at a predetermined time.

In conjunction with the sixth aspect or the first possible implementation of the sixth aspect, in a second possible implementation, the method may further include:

determining a second transmission and processing time period, where the second transmission and processing time period includes a transmission and processing time period from a time when the centralized computation center starts to send downlink subframe data to a time when the RRU sends the downlink subframe data, or the second transmission and processing time period includes a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data;

where the sending virtual feedback information of the uplink data and/or scheduling information of the uplink data to the RRU before a decoding result of the uplink data is obtained may include:

sending the virtual feedback information of the uplink data and/or the scheduling information of the uplink data to the RRU n1 subframes in advance, where a time duration of the n1 subframes is longer than or equal to the second transmission and processing time period.

In conjunction with the second possible implementation of the sixth aspect, in a third possible implementation, the method may further include:

sending, after the decoding result of the uplink data is obtained, true feedback information of the uplink data to the RRU, which in turn sends the true feedback information to the user terminal.

In conjunction with the third possible implementation of the sixth aspect, in a fourth possible implementation, the virtual feedback information may include an identifier for identifying the virtual feedback information, and the true feedback information may include an identifier for identifying the true feedback information.

According to a seventh aspect of the present disclosure, a feedback method for an uplink hybrid automatic repeat request is provided, which includes:

receiving virtual feedback information of uplink data and/or scheduling information of the uplink data sent by a centralized computation center or a local computation center, where the virtual feedback information of the uplink data and/or the scheduling information of the uplink data is sent, in a case that a first transmission and processing time period is longer than a predetermined feedback delay and before a decoding result of the uplink data is obtained, to a remote radio unit RRU by the centralized computation center or the local computation center; and the first transmission and processing time period includes a transmission and processing time period from a time when the uplink data is received by the RRU to a time when the RRU sends feedback information of the uplink data; and

sending the virtual feedback information of the uplink data and/or the scheduling information of the uplink data to a user terminal in a predetermined subframe.

In a first possible implementation, before the receiving virtual feedback information of uplink data and/or scheduling information of the uplink data sent by a centralized computation center or a local computation center, the method may further include:

receiving first instruction information sent by the centralized computation center, where the first instruction information is used to instruct the user terminal to start physical layer processing on data to be retransmitted and/or new data at a predetermined time; and

sending the first instruction information to the user terminal.

In conjunction with the seventh aspect or the first possible implementation of the seventh aspect, in a second possible implementation, the virtual feedback information of the uplink data and/or the scheduling information of the uplink data is sent, in a case that the first transmission and processing time period is longer than a predetermined feedback delay, to the RRU by the centralized computation center n1 subframes in advance or to the RRU by the local computation center n2 subframes in advance; a time duration of the n1 subframes is longer than or equal to the second transmission and processing time period; the second transmission and processing time period includes a transmission and processing time period from a time when the centralized computation center starts to send downlink subframe data to a time when the RRU sends the downlink subframe data, or the second transmission and processing time period includes a transmission and processing time period from a time when the centralized computation center starts to send the first instruction information to a time when the RRU sends downlink subframe data containing the first instruction information; a time duration of the n2 subframes is longer than or equal to a third transmission and processing time period; and the third transmission and processing time period includes a transmission and processing time period from a time when the local computation center starts to send downlink subframe data to a time when the RRU sends the downlink subframe data.

In conjunction with the second possible implementation of the seventh aspect, in a third possible implementation, the method may further include:

receiving true feedback information of the uplink data sent by the centralized computation center or the local computation center after a decoding result of the uplink data is obtained; and

sending the true feedback information to the user terminal.

In conjunction with the third possible implementation of the seventh aspect, in a fourth possible implementation, the virtual feedback information may include an identifier for identifying the virtual feedback information, and the true feedback information may include an identifier for identifying the true feedback information.

According to an eighth aspect of the present disclosure, a feedback method for an uplink hybrid automatic repeat request is provided, which includes:

receiving second instruction information for instructing to perform virtual feedback on uplink data and/or scheduling information of the uplink data sent by a centralized computation center, where the second instruction information is sent to a local computation center by the centralized computation center in a case that a first transmission and processing time period is longer than a predetermined feedback delay; and the first transmission and processing time period includes a transmission and processing time period from a time when the uplink data is received by the RRU to a time when the RRU sends feedback information of the uplink data; and

sending, before a decoding result of the uplink data is obtained, virtual feedback information of the uplink data and/or the scheduling information of the uplink data to the RRU, which in turn sends the virtual feedback information of the uplink data and/or the scheduling information of the uplink data to a user terminal in a predetermined subframe.

In a first possible implementation, before the receiving second instruction information for instructing to perform virtual feedback on uplink data and/or scheduling information of the uplink data sent by a centralized computation center, the method may further include:

receiving first instruction information sent by the centralized computation center, where the first instruction information is used to instruct the user terminal to start physical layer processing on data to be retransmitted and/or new data at a predetermined time; and

sending the first instruction information to the RRU, which in turn sends the first instruction information to the user terminal.

In conjunction with the eighth aspect or the first possible implementation of the eighth aspect, in a second possible implementation, the method may further include:

determining a third transmission and processing time period, where the third transmission and processing time period includes a transmission and processing time period from a time when the local computation center starts to send downlink subframe data to a time when the RRU sends the downlink subframe data;

where the sending, before a decoding result of the uplink data is obtained, virtual feedback information of the uplink data and/or the scheduling information of the uplink data to the RRU may include:

sending the virtual feedback information and/or the scheduling information of the uplink data to the RRU n2 subframes in advance, where a time duration of the n2 subframes is longer than or equal to the third transmission and processing time period.

In conjunction with the second possible implementation of the eighth aspect, in a third possible implementation, the method may further include:

sending, after the decoding result of uplink data is obtained, true feedback information of the uplink data to the RRU, which in turn sends the true feedback information to the user terminal.

In conjunction with the third possible implementation of the eighth aspect, in a fourth possible implementation, the virtual feedback information may include an identifier for identifying the virtual feedback information, and the true feedback information may include an identifier for identifying the true feedback information.

According to a ninth aspect of the present disclosure, a feedback method for an uplink hybrid automatic repeat request is provided, which includes:

receiving virtual feedback information of uplink data and/or scheduling information of the uplink data sent by a remote radio unit RRU in a predetermined subframe, where the virtual feedback information of the uplink data and/or the scheduling information of the uplink data is sent, in a case that a first transmission and processing time period is longer than a predetermined feedback delay and before a decoding result of the uplink data is obtained, to the RRU by a centralized computation center or a local computation center; and the first transmission and processing time period includes a transmission and processing time period from a time when the uplink data is received by the RRU to a time when the RRU sends feedback information of the uplink data; and

starting, based on the virtual feedback information of the uplink data and/or the scheduling information of the uplink data, physical layer processing on data to be retransmitted and/or new data at a predetermined time.

In a first possible implementation, before the receiving virtual feedback information of uplink data and/or scheduling information of the uplink data sent by an RRU in a predetermined subframe, the method may further include:

receiving first instruction information sent by the RRU, where the first instruction information is used to instruct a user terminal to start physical layer processing on data to be retransmitted and/or new data at a predetermined time.

In conjunction with the ninth aspect or the first possible implementation of the ninth aspect, in a second possible implementation, the virtual feedback information of the uplink data and/or the scheduling information of the uplink data is sent, in a case that the first transmission and processing time period is longer than a predetermined feedback delay, to the RRU by the centralized computation center n1 subframes in advance or to the RRU by the local computation center n2 subframes in advance;

a time duration of the n1 subframes is longer than or equal to the second transmission and processing time period; the second transmission and processing time period includes a transmission and processing time period from a time when the centralized computation center or the local computation center starts to send downlink subframe data to a time when the RRU sends the downlink subframe data, or the second transmission and processing time period includes a transmission and processing time period from a time when the centralized computation center or the local computation center starts to send the virtual feedback information of the uplink data and/or the scheduling information of the uplink data to a time when the RRU sends downlink subframe data containing the virtual feedback information of the uplink data and/or the scheduling information of the uplink data; and

a time duration of the n2 subframes is longer than or equal to a third transmission and processing time period; and the third transmission and processing time period includes a transmission and processing time period from a time when the local computation center starts to send downlink subframe data to a time when the RRU sends the downlink subframe data.

In conjunction with the second possible implementation of the ninth aspect, in a third possible implementation, the method may further include:

receiving true feedback information of the uplink data sent by the RRU, where the true feedback information of the uplink data is sent to the RRU by the centralized computation center or the local computation center after the decoding result of the uplink data is obtained; and

performing retransmission or new data transmission based on the true feedback information of the uplink data.

In conjunction with the third possible implementation of the ninth aspect, in a fourth possible implementation, the virtual feedback information may include an identifier for identifying the virtual feedback information, and the true feedback information may include an identifier for identifying the true feedback information.

According to a tenth aspect of the present disclosure, a computer storage medium is provided, where programs may be stored in the computer storage medium, and steps of the feedback method for an uplink hybrid automatic repeat request according to the sixth aspect or any possible implementation of the sixth aspect are performed when the programs are executed.

According to an eleventh aspect of the present disclosure, a computer storage medium is provided, where programs may be stored in the computer storage medium, and steps of the feedback method for an uplink hybrid automatic repeat request according to the seventh aspect or any possible implementation of the seventh aspect are performed when the programs are executed.

According to a twelfth aspect of the present disclosure, a computer storage medium is provided, where programs may be stored in the computer storage medium, and steps of the feedback method for an uplink hybrid automatic repeat request according to the eighth aspect or any possible implementation of the eighth aspect are performed when the programs are executed.

According to a thirteenth aspect of the present disclosure, a computer storage medium is provided, where programs may be stored in the computer storage medium, and steps of the feedback method for an uplink hybrid automatic repeat request according to the ninth aspect or any possible implementation of the ninth aspect are performed when the programs are executed.

According to a fourteenth aspect of the present disclosure, a centralized computation center including a first output device and a first processor is provided, where

the first processor is configured to determine a first transmission and processing time period, where the first transmission and processing time period includes a transmission and processing time period from a time when uplink data is received by a remote radio unit RRU to a time when the RRU sends feedback information of the uplink data; and

the first output device is configured to send, in a case that the first transmission and processing time period is longer than a predetermined feedback delay and before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

In a first possible implementation, the first output device may be further configured to send first instruction information to the RRU, which in turn sends the first instruction information to the user terminal; where the first instruction information is used to instruct the user terminal to start physical layer processing on data to be retransmitted and/or new data at a predetermined time.

In conjunction with the fourteenth aspect or a first possible implementation of the fourteenth aspect, in a second possible implementation, where

the first processor is further configured to determine a second transmission and processing time period, where the second transmission and processing time period includes a transmission and processing time period from a time when the centralized computation center starts to send downlink subframe data to a time when the RRU sends the downlink subframe data, or the second transmission and processing time period includes a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data; and

the first output device is configured to send the virtual feedback information of the uplink data and/or the scheduling information of the uplink data to the RRU n1 subframes in advance, and a time duration of the n1 subframes is longer than or equal to the second transmission and processing time period.

In conjunction with the second possible implementation of the fourteenth aspect, in a third possible implementation, the first output device may be further configured to send true feedback information of the uplink data to the RRU, where the RRU sends the true feedback information to the user terminal.

In conjunction with the third possible implementation of the fourteenth aspect, in a fourth possible implementation, the virtual feedback information may include an identifier for identifying the virtual feedback information, and the true feedback information may include an identifier for identifying the true feedback information.

According to a fifteenth aspect of the present disclosure, a remote radio unit including a second input device and a second output device is provided, where

the second input device is configured to receive virtual feedback information of uplink data and/or scheduling information of the uplink data sent by a centralized computation center or a local computation center, where the virtual feedback information of the uplink data and/or the scheduling information of the uplink data is sent, in a case that first transmission and processing time period is longer than a predetermined feedback delay and before a decoding result of the uplink data is obtained, to the remote radio unit RRU by the centralized computation center or the local computation center; and the first transmission and processing time period includes a transmission and processing time period from a time when the uplink data is received by the RRU to a time when the RRU sends feedback information of the uplink data; and

the second output device is configured to send the virtual feedback information of the uplink data and/or the scheduling information of the uplink data to a user terminal in a predetermined subframe.

In a first possible implementation, the second input device may be further configured to receive first instruction information sent by the centralized computation center, and the first instruction information may be used to instruct the user terminal to start physical layer processing on data to be retransmitted and/or new data at a predetermined time; and

the second output device may be further configured to send the first instruction information to the user terminal.

In conjunction with the fifteenth aspect or the first possible implementation of the fifteenth aspect, in a second possible implementation, the virtual feedback information of the uplink data and/or the scheduling information of the uplink data is sent, in a case that a first transmission and processing time period is longer than a predetermined feedback delay, to the RRU by the centralized computation center n1 subframes in advance or to the RRU by the local computation center n2 subframes in advance; a time duration of the n1 subframes is longer than or equal to the second transmission and processing time period; the second transmission and processing time period includes a transmission and processing time period from a time when the centralized computation center starts to send downlink subframe data to a time when the RRU sends the downlink subframe data, or the second transmission and processing time period includes a transmission and processing time period from a time when the centralized computation center starts to send the first instruction information to a time when the RRU sends downlink subframe data containing the first instruction information; a time duration of the n2 subframes is longer than or equal to a third transmission and processing time period; and the third transmission and processing time period includes a transmission and processing time period from a time when the local computation center starts to send downlink subframe data to a time when the RRU sends the downlink subframe data.

In conjunction with the second possible implementation of the fifteenth aspect, in a third possible implementation,

the second input device may be further configured to receive true feedback information of the uplink data sent by the centralized computation center or the local computation center after a decoding result of the uplink data is obtained; and

the second output device may be further configured to send the true feedback information to the user terminal.

In conjunction with the third possible implementation of the fifteenth aspect, in a fourth possible implementation, the virtual feedback information may include an identifier for identifying the virtual feedback information and the true feedback information may include an identifier for identifying the true feedback information.

According to a sixteenth aspect of the present disclosure, a local computation center including a third input device and a third output device is provided, where

the third input device is configured to receive second instruction information for instructing to perform virtual feedback on uplink data and/or scheduling information of the uplink data sent by a centralized computation center, where the second instruction information is sent to the local computation center by the centralized center in a case that a first transmission and processing time period is longer than a predetermined feedback delay; and the first transmission and processing time period includes a transmission and processing time period from a time when the uplink data is received by the RRU to a time when the RRU sends feedback information of the uplink data; and

the third output device is configured to send, before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

In a first possible implementation, the third input device may be further configured to receive first instruction information sent by the centralized computation center, where the first instruction information is used to instruct the user terminal to start physical layer processing on data to be retransmitted and/or new data at a predetermined time; and

the third output device may be further configured to send the first instruction information to the RRU, which in turn sends the first instruction information to the user terminal.

In conjunction with the sixteenth aspect or the first possible implementation of the sixteenth aspect, in a second possible implementation, the local computation center may further include a third processor, where

the third processor is configured to determine a third transmission and processing time period, and the third transmission and processing time period includes a transmission and processing time period from a time when the local computation center starts to send downlink subframe data to a time when the RRU sends the downlink subframe data; and

the third output device is configured to send the virtual feedback information and/or the scheduling information of the uplink data to the RRU n2 subframes in advance, where a time duration of the n2 subframes is longer than or equal to the third transmission and processing time period.

In conjunction with the second possible implementation of the sixteenth aspect, in a third possible implementation, the third output device may be further configured to send true feedback information of the uplink data to the RRU, where the RRU sends the true feedback information to the user terminal.

In conjunction with the third possible implementation of the sixteenth aspect, in a fourth possible implementation, the virtual feedback information may include an identifier for identifying the virtual feedback information, and the true feedback information may include an identifier for identifying the true feedback information.

According to a seventeenth aspect, a user terminal including a fourth input device and a fourth processor is provided, where

the fourth input device is configured to receive virtual feedback information of uplink data and/or scheduling information of the uplink data sent by a remote radio unit RRU in a predetermined subframe; the virtual feedback information of the uplink data and/or the scheduling information of the uplink data is sent, in a case that a first transmission and processing time period is longer than a predetermined feedback delay and before a decoding result of the uplink data is obtained, to the RRU by a centralized computation center or a local computation center; and the first transmission and processing time period includes a transmission and processing time period from a time when the uplink data is received by the RRU to a time when the RRU sends feedback information of the uplink data; and

the fourth processor is configured to start, based on the virtual feedback information of the uplink data and/or the scheduling information of the uplink data, physical layer processing on data to be retransmitted and/or new data at a predetermined time.

In a first possible implementation, the fourth input device may be further configured to receive first instruction information sent by the RRU, where the first instruction information is used to instruct a user terminal to start physical layer processing on data to be retransmitted and/or new data at a predetermine time.

In conjunction with the seventeenth aspect or the first possible implementation of the seventeenth aspect, in a second implementation, the virtual feedback information of the uplink data and/or the scheduling information of the uplink data is sent, in a case that the first transmission and processing time period is longer than a predetermined feedback delay, to the RRU by the centralized computation center n1 subframes in advance or to the RRU by the local computation center n2 subframes in advance;

a time duration of the n1 subframes is longer than or equal to the second transmission and processing time period; the second transmission and processing time period includes a transmission and processing time period from a time when the centralized computation center or the local computation center starts to send downlink subframe data to a time when the RRU sends the downlink subframe data; or the second transmission and processing time period includes a transmission and processing time period from a time when the centralized computation center or the local computation center starts to send the virtual feedback information of the uplink data and/or the scheduling information of the uplink data to a time when the RRU sends downlink subframe data containing the virtual feedback information of the uplink data and/or the scheduling information of the uplink data; and

a time duration of the n2 subframes is longer than or equal to a third transmission and processing time period; and the third transmission and processing time period includes a transmission and processing time period from a time when the local computation center starts to send downlink subframe data to a time when the RRU sends the downlink subframe data.

In conjunction with the second possible implementation of the seventeenth aspect, in a third possible implementation,

the fourth input device may be further configured to receive true feedback information of the uplink data sent by the RRU, where the true feedback information of the uplink data is sent to the RRU by the centralized computation center or the local computation center after a decoding result of the uplink data is obtained; and

the fourth processor may be further configured to perform retransmission or new data transmission based on the true feedback information of the uplink data.

In conjunction with the third possible implementation of the seventeenth aspect, in a fourth possible implementation, the virtual feedback information may include an identifier for identifying the virtual feedback information, and the true feedback information may include an identifier for identifying the true feedback information.

It follows that, in some possible implementations of the present disclosure, firstly the first transmission and processing time period for uplink data feedback is determined; in a case that the first transmission and processing time period is longer than a predetermined feedback delay, the centralized computation center or the local computation center sends the virtual feedback information of the uplink data and/or the scheduling information of the uplink data before a decoding result of the uplink data is obtained; and in this way, the UE performs physical layer processing on new data or data to be retransmitted in advance, and the extra transmission delay caused by the transport network can be compensated, and thereby maintaining round trip time RTT of one process, ensuring the performance of the user service and ensuring data throughput of the user terminal.

### BRIEF DESCRIPTION OF THE DRAWINGS

In order to illustrate technical solutions in embodiments of the present disclosure or the conventional technology more clearly, hereinafter drawings to be used in the description of the embodiments are introduced simply. Apparently, the drawings described below only describe some embodiments of the present disclosure, and other drawings may be obtained based on these drawings by those skilled in the art without any creative work.

FIG. 1A is a first schematic structural diagram of a C-RAN architecture according to the conventional technology;

FIG. 1B is a second schematic structural diagram of a C-RAN architecture according to the conventional technology;

FIG. 2 is a schematic flowchart of a feedback method for an uplink hybrid automatic repeat request according to a first embodiment of the present disclosure;

FIG. 3A is a schematic diagram showing data flow and time constitution for uplink data feedback in the C-RAN architecture shown in FIG. 1A;

FIG. 3B is a schematic diagram showing data flow and time constitution for uplink data feedback in the C-RAN architecture shown in FIG. 1B;

FIG. 4 is a first schematic flowchart of a feedback method for an uplink hybrid automatic repeat request according to a second embodiment of the present disclosure;

FIG. 5 is a second schematic flowchart of a feedback method for an uplink hybrid automatic repeat request according to the second embodiment of the present disclosure;

FIG. 6 is a first schematic flowchart of a feedback method for an uplink hybrid automatic repeat request according to a third embodiment of the present disclosure;

FIG. 7 is a second schematic flowchart of a feedback method for an uplink hybrid automatic repeat request according to the third embodiment of the present disclosure;

FIG. 8 is a third schematic flowchart of a feedback method for an uplink hybrid automatic repeat request according to the third embodiment of the present disclosure;

FIG. 9 is a schematic structural diagram of a centralized computation center according to a fourth embodiment of the present disclosure;

FIG. 10 is a schematic structural diagram of a remote radio unit according to a fifth embodiment of the present disclosure;

FIG. 11 is a schematic structural diagram of a local computation center according to a sixth embodiment of the present disclosure;

FIG. 12 is a schematic structural diagram of a user terminal according to a seventh embodiment of the present disclosure;

FIG. 13 is a schematic structural diagram of a feedback system for an uplink hybrid automatic repeat request according to an eighth embodiment of the present disclosure; and

FIG. 14 is a schematic diagram of a first example according to an embodiment of the present disclosure;

FIG. 15 is a schematic diagram of a second example according to an embodiment of the present disclosure;

FIG. 16 is a schematic structural diagram of a centralized computation center according to a tenth embodiment of the present disclosure;

FIG. 17 is a schematic structural diagram of a remote radio unit according to an eleventh embodiment of the present disclosure;

FIG. 18 is a schematic structural diagram of a local computation center according to a twelfth embodiment of the present disclosure; and

FIG. 19 is a schematic structural diagram of a user terminal according to a thirteenth embodiment of the present disclosure.

### DETAILED DESCRIPTION OF THE EMBODIMENTS

Hereinafter technical solutions in embodiments of the present disclosure are described clearly and completely in conjunction with drawings in the embodiments of the present disclosure. Apparently, the described embodiments are some rather all of the embodiments of the present disclosure. Any other embodiments obtained based on the embodiments of the present disclosure by those skilled in the art without any creative work fall within the scope of protection of the present disclosure.

According to the embodiments of the present disclosure, a feedback method and feedback system for an uplink hybrid automatic repeat request and a related device are provided, which are described in detail below respectively.

Terms “first”, “second”, “third” and “fourth” and so on in the specification, claims and the above drawings of the present disclosure (if there are the terms) are used to distinguish similar objects, and are not intended to describe a particular order or sequencing. It should be understood the terms may be exchanged in a certain case, such that the embodiments of the present disclosure described here may be implemented in an order different from the order illustrated or described here for example. In addition, terms “including” and “having” and any variations thereof are intended to be inclusive and nonexclusive. For example, a process, a method, a system, a product or a device including a series of steps or units is not limited to include the clearly listed steps or units, but may include other steps or units not listed clearly or inherent for the process, the method, the product or the device.

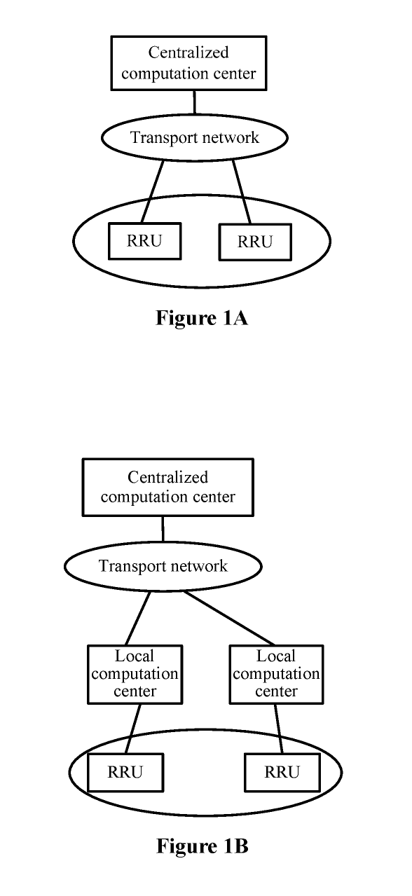

In an architecture shown in FIG. 1A, BBUs (Base band unit) of multiple base stations are centralized to form a centralized computation center, which can support massive joint processing to improve a system capacity and utilize resource statistical multiplexing to reduce a system cost efficiently. For the massive joint processing, data for respective RRUs (Remote radio unit) needs to be transmitted back to the BBU resource pool over a long distance, and a data transmission rate on a CPRI (Common Public Radio Interface) increases linearly with the number of antennas and a system bandwidth. For example, a system bandwidth of an LTE (Long Term Evolution) is 20 MHz and a transmission traffic may reach 10 Gbps in case of using 8 antennas; such a large transmission bandwidth brings great challenge to the transmission network of the conventional access layer and it is difficult to deploy for a service provider whose fiber resource is not rich. In addition, viewed from a joint signal processing gain, it is not necessary for all the users to be connected to a uniform cloud computation node, and there is an obvious joint processing gain only for users at an edge of a cell. Hence, in a case that a part of user data baseband processing, even L2 processing, is performed locally, a ratio of data to be transmitted to a cloud computation center is reduced greatly, and thereby saving the bandwidth. In hierarchical adaptive cloud computation radio access network architecture as shown in FIG. 1B, local computation centers are provided, and tasks to be performed by the local computation centers and the centralized computation center may be assigned as needed.

Downlink Direction

The local computation centers may at most complete all the baseband processing of a physical layer, including channel encoding, modulating, precoding processing, resource block mapping, IFFT (Inverse fast Fourier transform) and inserting a CP (Cyclic prefix) and so on.

Besides the physical layer processing described above, the local computation centers may reserve resource to perform link layer processing and high layer signaling processing, and interface with a backbone network via a standard interface (for example an S1 interface of the LTE system).

Completing the link layer processing and the high layer signaling processing, the centralized computation center may interface with the backbone network via a standard interface (for example the S1 interface of the LTE system), and may also generate precoding control information.

Uplink Direction

The local computation centers receive IQ (In-phase and Quadrature) data sent by the RRU, and performs removing of the CP, FFT (fast Fourier transform), frequency domain data extracting, channel separating, channel estimating, measuring, demodulating, decoding and so on.

Besides the physical layer processing described above, the local computation centers may reserve resource to perform link layer processing and may interface with the backbone network via a standard interface (for example the S1 interface of the LTE system).

The centralized computation center receives user data in frequency domain sent by the local computation centers, performs joint demodulating, joint decoding, link layer processing, high layer signaling processing and so on, and may interface with the backbone network via a standard interface (for example the S1 interface of the LTE system).

Generally, uplink CoMP (Coordinated multi-point) user data is demodulated and decoded jointly at the centralized computation center, while non-uplink CoMP user data may be processed directly at the local computation centers and then transmitted to a core network via the standard interface. The non-uplink CoMP user data may also be processed at the centralized computation center depending on the processing ability of the computation centers, the network transmission ability of the centralized computation center and the local computation centers and the transmission ability of the back end backbone. The centralized computation center is connected to the local computation centers through the transport network, and an extra transmission delay may occur due to the limitation of the transmission bandwidth and real-time change of network traffic. Presently, in the LTE system, a strict transmission delay requirement is applied on two processes, i.e., PRACH (Physical downlink control channel) feedback process and HARQ (Hybrid automatic repeat request) feedback retransmission, where a size of a feedback window for the PRACH may be set and hence the extra transmission delay may be compensated; but the HARQ feedback is susceptible to be influenced.

Hereinafter the delay in the HARQ feedback retransmission process is analyzed.

For downlink HARQ, data sending and ACK/NACK feedback are not performed through the transport network and an asynchronous mode is used in downlink retransmission, hence the extra delay caused by the transport network has no influence on HARQ timing itself.

For uplink HARQ, data sending and ACK/NACK feedback are performed through the transport network, and the extra delay may postpone sending point in time for the ACK/NACK but has no influence on the uplink retransmission.

Hence, for ACK/NACK feedback for uplink data, since the uplink data and downlink ACK/NACK feedback each are sent through the transport network, the extra transmission delay may influence a feedback point in time. For example, in a case that the transmission time period or the processing time period is long, the feedback time instant is later than that stipulated in the conventional protocol, and thereby increasing HARQ RTT and influencing the service performance.

### First Embodiment

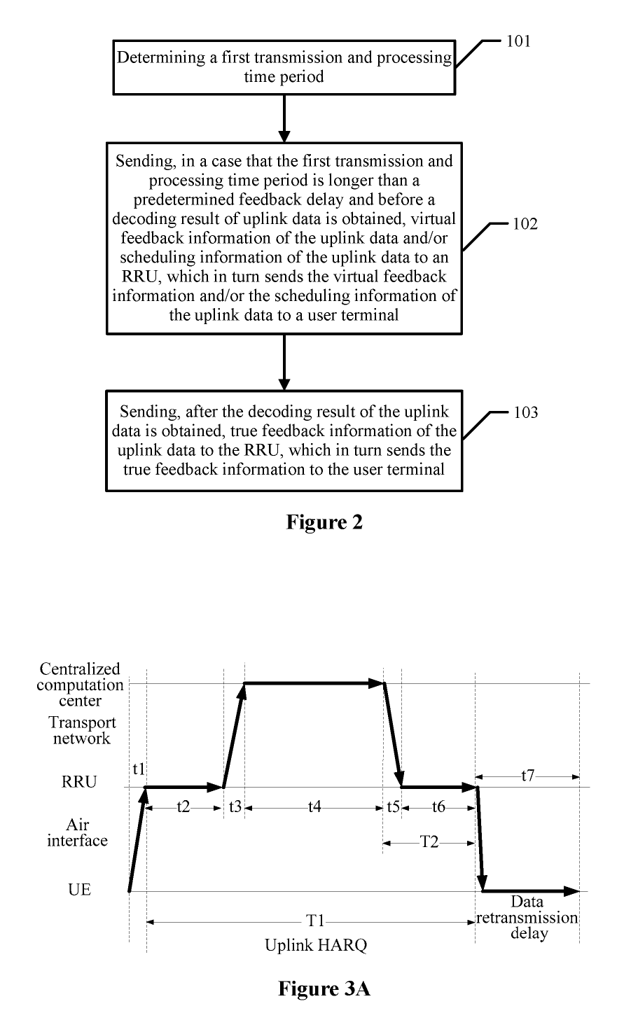

According to the present disclosure, a feedback method for an uplink hybrid automatic repeat request is provided. As shown in FIG. 2, the method is as follows.

At 101, a first transmission and processing time period is determined, where the first transmission and processing time period includes a transmission and processing time period from a time instant when uplink data is received by a remote radio unit RRU to a time instant when the RRU sends feedback information of the uplink data.

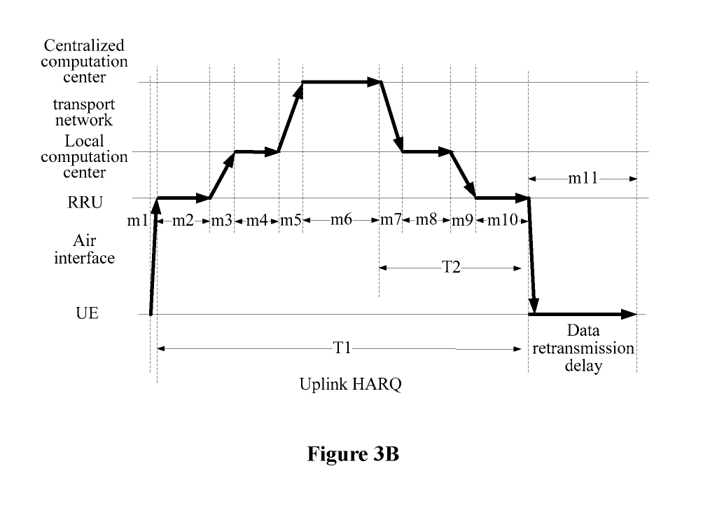

As shown in FIG. 3A, in the C-RAN architecture shown in FIG. 1A, the first transmission and processing time period T1 includes: a processing time period t2 for processing uplink data by the RRU, a transmission time period t3 for transmitting the uplink data from the RRU to the centralized computation center through the transport network, a processing time period t4 for processing the uplink data and generating downlink subframe data by the centralized computation center, a transmission time period t5 for transmitting the downlink subframe data containing the feedback information of the uplink data (ACK/NACK) and/or scheduling information of the uplink data from the centralized computation center to the RRU through the transport network, and a processing time period t6 for processing the downlink subframe data by the RRU.

As shown in FIG. 3B, in the C-RAN architecture shown in FIG. 1B, the first transmission and processing time period T1 includes: a processing time period m2 for processing uplink data by the RRU, a transmission time period m3 for transmitting the uplink data from the RRU to a local computation center via the CPRI, a processing time period m4 for processing the uplink data by the local computation center, a transmission time period m5 for transmitting the uplink data from the local computation center to the centralized computation center through the transport network, a processing time period m6 for processing the uplink data by the centralized computation center, a transmission time period m7 for transmitting feedback information of the uplink data and/or scheduling information of the uplink data from the centralized computation center to the local computation center through the transport network, a processing time period m8 for generating downlink subframe data by the local computation center based on the feedback information of the uplink data and/or the scheduling information of the uplink data, a transmission time period m9 for transmitting the downlink subframe data (containing the feedback information of the uplink data and/or the scheduling information of the uplink data) from the local computation center to the RRU via the CPRI, and a processing time period m10 for processing the downlink subframe data by the RRU.

At 102, in a case that the first transmission and processing time period is longer than a predetermined feedback delay and before a decoding result of the uplink data is obtained, virtual feedback information of the uplink data and/or the scheduling information of the uplink data is sent to the RRU, which in turn sends the virtual feedback information of the uplink data and/or the scheduling information of the uplink data to a user terminal in a predetermined subframe.

In the conventional technology, for either FDD (Frequency Division Duplex) or TDD (Time Division Duplex) in the LTE system, ACK/NACK feedback, which indicates whether a transmission is performed correctly, is provided in a fixed subframe, i.e., ACK/NACK in a k-th subframe is the feedback for uplink data transmitted in a (k−n)-th subframe, and n is constant, i.e. 4, in an LTE FDD system. In a TDD system, the value of n varies depending on uplink/downlink configurations, and the value of n varies between 4 and 7, as shown in the following table.

| TDD uplink/downlink | subframe number | | | | | | | | | |
|---|---|---|---|---|---|---|---|---|---|---|
| configuration type | 0 | 1 | 2 | 3 | 4 | 5 | 6 | 7 | 8 | 9 |
| 0 | 7 | 4 | — | — | — | 7 | 4 | — | — | — |
| 1 | — | 4 | — | — | 6 | — | 4 | — | — | 6 |
| 2 | — | — | — | 6 | — | — | — | — | 6 | — |
| 3 | 6 | — | — | — | — | — | — | — | 6 | 6 |
| 4 | — | — | — | — | — | — | — | — | 6 | 6 |
| 5 | — | — | — | — | — | — | — | — | 6 | — |
| 6 | 6 | 4 | — | — | — | 7 | 4 | — | — | 6 |

For example, in case of k=6, n=4 and k−n=2, i.e., feedback for uplink data transmitted in a second subframe is provided in a sixth subframe.

The feedback delay may be set in advance, for example the predetermined feedback delay may be set as time duration of n subframes.

In a case that the feedback delay is set as the time duration of n subframes in advance and the first transmission and processing time period is longer than the predetermined feedback delay, the RRU can not provide feedback of the uplink data in a predetermined subframe, for example feedback for uplink data transmitted in a (k−n)-th subframe can not be provided in a k-th subframe.

The virtual feedback information may be virtual ACK and may be generated by the centralized computation center.

Since the first transmission and processing time period is too long and the feedback for the uplink data can not be provided in accordance with the stipulation in the conventional protocol, before obtaining a decoding result of the uplink data, the centralized computation center may send virtual feedback information and/or scheduling information of the uplink data to the RRU, which may in turn forward the virtual feedback information and/or the scheduling information of the uplink data to a user terminal (UE) in a predetermined subframe. That is, for uplink data transmitted in the (k−n)-th subframe, the RRU sends virtual feedback information of the uplink data and/or scheduling information of the uplink data to the UE in a predetermined k-th subframe. After receiving the virtual feedback information and/or the scheduling information of the uplink data, the user terminal may start physical layer processing on data to be retransmitted and/or new data at a predetermined time instant based on the virtual feedback information and/or the scheduling information of the uplink data.

It should be noted that, in a case that the first transmission and processing time period is shorter than or equal to the predetermined feedback delay, step 103 may be directly performed without performing step 102, i.e., performing a normal feedback flow.

At 103, after the decoding result of the uplink data is obtained, true feedback information of the uplink data is sent to the RRU, which in turn sends the true feedback information to the user terminal.

After obtaining the decoding result and before retransmitting the subframe, the centralized computation center feeds back true ACK/NACK information to the user terminal in a subsequent downlink subframe, and the user terminal determines whether to transmit new data or perform retransmission based on the received second ACK/NACK feedback for the same process.

It should be noted that, for the C-RAN architecture shown in FIG. 1B, messages transmitted between the centralized computation center and the RRU may be processed and forwarded by the local computation center, and the related content relates to the conventional technology and is not described detailed here.

In the embodiment, in a case that the first transmission and processing time period is longer than a predetermined feedback delay and the feedback for the uplink data can not be provided in accordance with the stipulation in the conventional protocol, the centralized computation center sends the virtual feedback information and/or the scheduling information of the uplink data to the user terminal in advance rather than waiting for the decoding result and then providing feedback in accordance with the stipulation in the conventional protocol. Thereby the user terminal may still prepare the uplink transmission data at a time instant stipulated in the conventional protocol based on the virtual feedback information and/or the scheduling information of the uplink data, and thereby avoiding increasing the HARQ RTT and improving the service performance.

### Second Embodiment

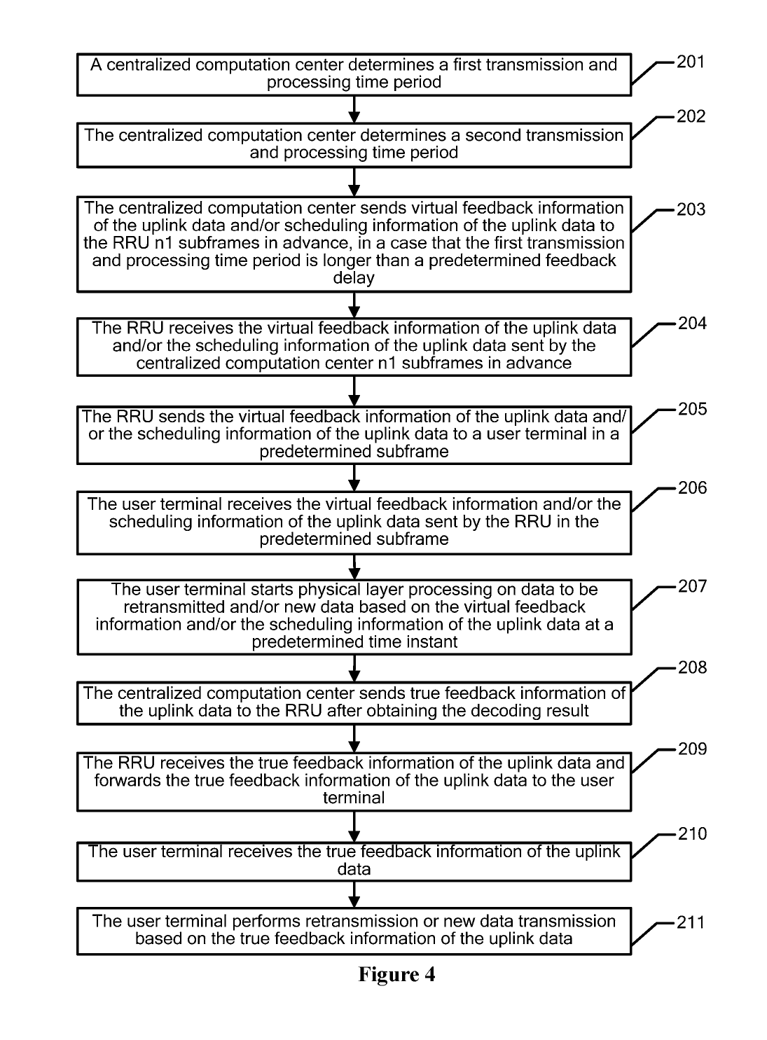

According to the present disclosure, a feedback method for an uplink hybrid automatic repeat request is provided. As shown in FIG. 4, the method is as follows.

At 201, a centralized computation center determines a first transmission and processing time period, where the first transmission and processing time period includes a transmission and processing time period from a time instant when uplink data is received by a remote radio unit RRU to a time instant when the RRU sends feedback information of the uplink data

As shown in FIG. 3A, in the C-RAN architecture shown in FIG. 1A, the first transmission and processing time period T1 includes: a processing time period t2 for processing uplink data by the RRU, a transmission time period t3 for transmitting the uplink data from the RRU to the centralized computation center through the transport network, a processing time period t4 for processing the uplink data and generating downlink subframe data by the centralized computation center, a transmission time period t5 for transmitting the downlink subframe data containing the feedback information of the uplink data (ACK/NACK) and/or scheduling information of the uplink data from the centralized computation center to the RRU through the transport network, and a processing time period t6 for processing the downlink subframe data by the RRU.

As shown in FIG. 3B, in the C-RAN architecture shown in FIG. 1B, the first transmission and processing time period T1 includes: a processing time period m2 for processing uplink data by the RRU, a transmission time period m3 for transmitting the uplink data from the RRU to a local computation center via the CPRI, a processing time period m4 for processing the uplink data by the local computation center, a transmission time period m5 for transmitting the uplink data from the local computation center to the centralized computation center through the transport network, a processing time period m6 for processing the uplink data by the centralized computation center, a transmission time period m7 for transmitting feedback information of the uplink data and/or scheduling information of the uplink data from the centralized computation center to the local computation center through the transport network, a processing time period m8 for generating downlink subframe data by the local computation center based on the feedback information of the uplink data and/or the scheduling information of the uplink data, a transmission time period m9 for transmitting the downlink subframe data from the local computation center to the RRU via the CPRI, and a processing time period m10 for processing the downlink subframe data by the RRU.

In step 202, the centralized computation center determines a second transmission and processing time period, where the second transmission and processing time period includes a transmission and processing time period from a time instant when the centralized computation center starts to send downlink subframe data to a time instant when the RRU sends the downlink subframe data, or the second transmission and processing time period includes a transmission and processing time period from a time instant when the centralized computation center starts to send virtual feedback information of the uplink data and/or scheduling information of the uplink data to a time instant when the RRU sends downlink subframe data including the virtual feedback information of the uplink data and/or the scheduling information of the uplink data.

As shown in FIG. 3A, in the C-RAN architecture shown in FIG. 1A, the second transmission and processing time period T2 includes: a transmission time period t5 for transmitting the downlink subframe data containing the feedback information of the uplink data (ACK/NACK) and/or the scheduling information of the uplink data from the centralized computation center to the RRU through the transport network, and a processing time period t6 for processing the downlink subframe data containing the feedback information of the uplink data and/or the scheduling information of the uplink data, by the RRU.

As shown in FIG. 3B, in the C-RAN architecture shown in FIG. 1B, the second transmission and processing time period T2 includes: a transmission time period m7 for transmitting the feedback information of the uplink data and/or the scheduling information of the uplink data from the centralized computation center to local computation center through the transport network, a processing time period m8 for generating downlink subframe data by the local computation center based on the feedback information of the uplink data and/or the scheduling information of the uplink data, a transmission time period m9 for transmitting the downlink subframe data from the local computation center to the RRU via the CPRI, and a processing time period m10 for processing the downlink subframe data by the RRU.

The first transmission and processing time period T1 and the second transmission and processing time period T2 may be determined by planning in an off-line manner or measuring in a real time manner by the centralized computation center.

At 203, in a case that the first transmission and processing time period T1 is longer than a predetermined delay, the centralized computation center sends virtual feedback information of the uplink data and/or scheduling information of the uplink data to the RRU n1 subframes in advance.

In the embodiment, the predetermined feedback delay may be the same as that described in the first embodiment, which is not described detailed here.

In the embodiment, the “n1 subframes in advance” is relative to the predetermined subframe which will be described below.

Time duration of the n1 subframes is longer than or equal to the second transmission and processing time period. For example, in a case that the second transmission and processing time period is 2.5 ms and a time duration of one subframe is 1 ms, the value of n1 may be 3.

In the embodiment, the virtual feedback information of the uplink data and/or the scheduling information of the uplink data is sent n1 subframes in advance, such that the RRU can send the virtual feedback information of the uplink data and/or the scheduling information of the uplink data to a user terminal in a predetermined subframe.

At 204, the RRU receives the virtual feedback information of the uplink data and/or the scheduling information of the uplink data sent by the centralized computation center n1 subframes in advance.

At 205, the RRU sends the virtual feedback information of the uplink data and/or the scheduling information of the uplink data to the user terminal in a predetermined subframe.

In order to compensate the long transmission time period or processing time period, the centralized computation center may send the virtual feedback information and/or the scheduling information of the uplink data to the RRU n1 subframes in advance with respect to the time stipulated by the conventional protocol (in order to compensate the second transmission and processing time period T2), and in this way, the RRU may send the virtual feedback information and/or the scheduling information of the uplink data to the UE in a subframe stipulated by the conventional protocol (i.e., the predetermined subframe). For example, for uplink data uploaded in a (k−n)-th subframe, the value of n1 may be determined after T2 is determined, the virtual feedback information and/or the scheduling information of the uplink data may be sent to the RRU in a (k−n1)-th subframe, and in this way the RRU may send the virtual feedback information and/or the scheduling information of the uplink data to a UE in a k-th subframe.

At 206, the user terminal receives the virtual feedback information and/or the scheduling information of the uplink data sent by the RRU in the predetermined subframe.

At 207, the user terminal starts physical layer processing on data to be retransmitted and/or new data based on the virtual feedback information and/or the scheduling information of the uplink data at a predetermined time instant.

Specifically, after receiving the virtual feedback information and/or the scheduling information of the uplink data, the user terminal may retain cached waiting reply data based on the virtual feedback information and perform physical layer processing, for example modulating and encoding, on the data to be retransmitted based on an HARQ mode, and may also perform physical layer processing, for example modulating and encoding, on new data based on the scheduling information of the uplink data. The waiting reply data corresponds to a MAC (Media access control) PDU (Packet data unit) of one uplink scheduling. The data to be retransmitted corresponds to data to be retransmitted per HARQ for the MAC PDU which has been encoded, and the data to be retransmitted may be a copy of transmitted data or may be different from the transmitted data, depending on HARQ modes.

For uplink synchronous retransmission, the data may be retransmitted by using a non-adaptive mode or an adaptive mode. In the non-adaptive mode, the data is retransmitted using the same modulation and encoding mode and time-frequency resource block as that in previous transmission; and in the adaptive mode, the data may be retransmitted using a modulation and encoding mode different from that in the previous transmission based on a current channel state, or data blocks with different length are transmitted using different time-frequency resource with respect to the previous transmission. For different uplink retransmission modes, the scheduling information of the uplink data and processing performed by the UE terminal may vary.

Non-adaptive retransmission: if scheduling of uplink new data is not authorized in a subframe for feeding back a virtual ACK, a PDCCH (Physical random access channel) does not include scheduling information of uplink data of the user; and the UE performs processing, for example modulating and encoding, on the data to be retransmitted using the same modulation and encoding information as that in the previous transmission.

If scheduling of uplink new data is authorized in a subframe for feeding back a virtual ACK, resource block distribution in the scheduling information of the uplink data is the same as the resource block used in the previous transmission, information, such as modulation and encoding mode and transmission block length, reflects a channel state, and the UE performs processing, for example modulating and encoding, on new data based on the scheduling information.

Adaptive retransmission: the scheduling information includes information such as resource block distribution, modulation and encoding mode and transmission block length, and the UE performs processing, for example modulating and encoding, on the data to be retransmitted based on the scheduling information; if the UE is waiting for authorization of scheduling of new data, the UE performs processing, for example modulating and encoding, on the new data based on the scheduling information simultaneously.

In step 208, after obtaining the decoding result of the uplink data, the centralized computation center sends true feedback information of the uplink data to the RRU.

Preferably, after obtaining the decoding result of the uplink data, the centralized computation center may send the true feedback information as soon as possible, for example sending the true feedback information in a first downlink subframe after obtaining the decoding result.

It should be noted that, in a case that the first transmission and processing time period T1 is shorter than or equal to a predetermined feedback delay, step 209 may be directly performed without performing steps 203 to 208, i.e., performing normal feedback flow.

At 209, the RRU receives the true feedback information of the uplink data and forwards the true feedback information of the uplink data to the user terminal.

At 210, the user terminal receives the true feedback information of the uplink data.

At 211, the user terminal performs retransmission or new data transmission based on the true feedback information of the uplink data.

In the embodiment, in step 203, the centralized computation center sending virtual feedback information of the uplink data and/or scheduling information of the uplink data to the RRU may include the following three cases.

1. The centralized computation center sends the virtual feedback information of the uplink data and the scheduling information of the uplink data to the RRU, and thus, in step 207, the user terminal needs to start physical layer processing on data to be retransmitted and new data at the same time based on the virtual feedback information and the scheduling information of the uplink data at a predetermined time instant, and in step 211 the user terminal needs to retransmit the uplink data or transmit new data.

2. The centralized computation center sends the virtual feedback information of the uplink data to the RRU without sending scheduling information of the uplink data, and thus, in step 207, the user terminal only needs to start physical layer processing on data to be retransmitted based on the virtual feedback information at a predetermined time instant, and in step 211 the user terminal needs to perform retransmission.

3. The centralized computation center sends scheduling information of the uplink data to the RRU without sending virtual feedback information of the uplink data, and thus, in step 207, the user terminal needs to start physical layer processing on new data based on the scheduling information of the uplink data at a predetermined time instant and may start physical layer processing on data to be retransmitted simultaneously, and in step 211 the user terminal needs to performs retransmission or new data transmission.

Preferably, for cases 1 and 2, in order to facilitate the user terminal to distinguish the virtual feedback information and the true feedback information, the virtual feedback information may include an identifier for identifying the virtual feedback information and the true feedback information may include an identifier for identifying the true feedback information. Specifically, one identifier bit may be added in the feedback information to indicate whether the feedback information is virtual or true. For example 0 identifies the virtual feedback information and 1 identifies the true feedback information. Practically, the manner for identifying is not limited thereto, and those skilled in the art may select other manner for identifying as needed.

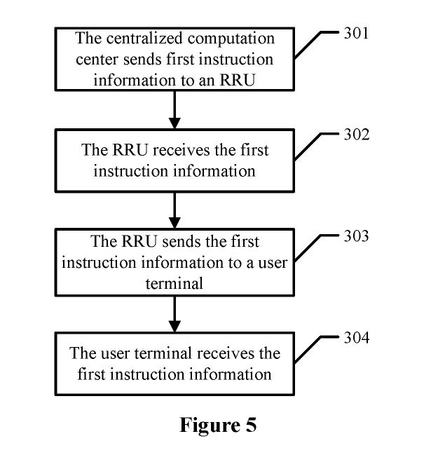

Preferably, for case 3, before step 203, the method may further include the following steps, as shown in FIG. 5.

At 301, the centralized computation center sends first instruction information to the RRU, where the first instruction information is used to instruct the user terminal to start physical layer processing on data to be retransmitted (or data to be retransmitted and new data) at a predetermined time instant.

At 302, the RRU receives the first instruction information.

At 303, the RRU sends the first instruction to information the user terminal.

At 304, the user terminal receives the first instruction information.

Since the user terminal receives the first instruction information in advance, in step 203 the centralized computation center may send no virtual feedback information to improve wireless transmission efficiency. This is because the user terminal may also start physical layer processing on the data to be retransmitted based on the first instruction information at a predetermined time instant in step 207, even if the user terminal receives no virtual feedback information.

Specifically, the first instruction information may include a process number or a corresponding subframe number for the physical layer processing performed on the data to be retransmitted and the new data, which is started by the user terminal at the predetermined time instant.

Preferably, the centralized computation center may send the first instruction information to the UE associated with the RRU by broadcasting, and practically those skilled in the art may use other ways for sending as needed, which is not limited here.

In the embodiment, according to the method, in a case that the first transmission time period is longer than a predetermined delay, the virtual feedback information and/or the scheduling information of the uplink data is sent n1 subframes in advance, such that the UE performs physical layer processing on the data to be retransmitted and/or new data at a time instant stipulated in the conventional protocol, and the extra transmission delay caused by the transport network can be compensated, and thereby maintaining Round Trip Time RTT of one process, ensuring the performance of the user service and ensuring data throughput of the user terminal.

### Third Embodiment

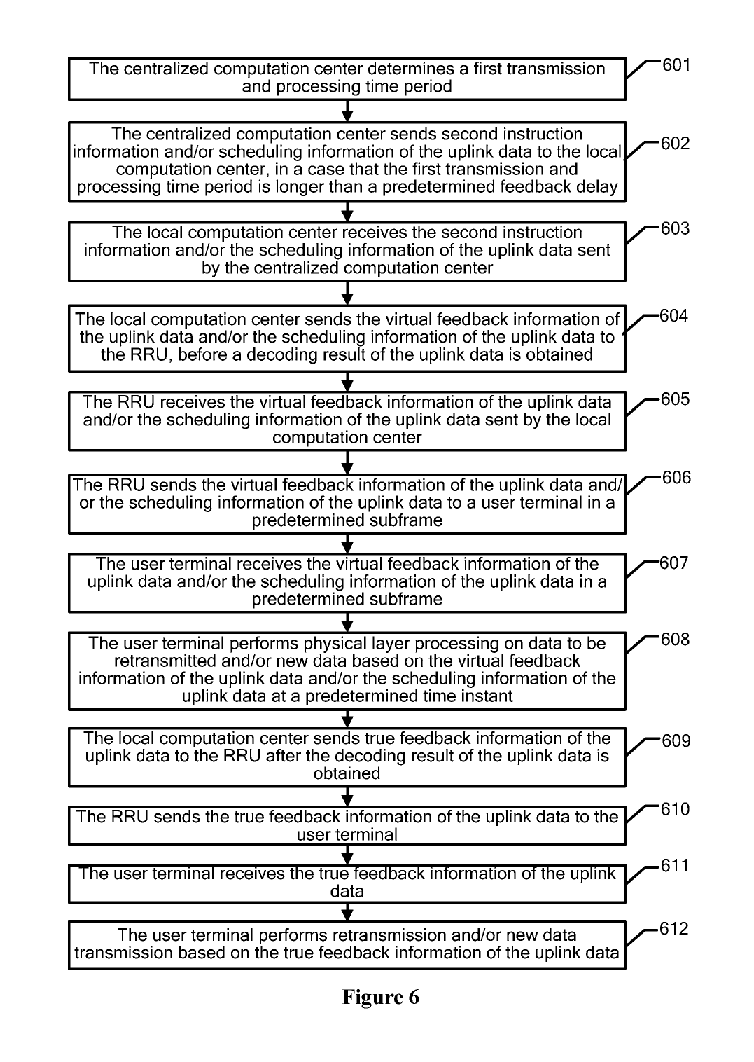

According to the present disclosure, a feedback method for an uplink hybrid automatic repeat request is provided. As shown in FIG. 6, the method is as follows.

At 601, a centralized computation center determines a first transmission and processing time period.

The definition of the first transmission and processing time period may be referred to the description in the above embodiments, which is not described here.

At 602, in a case that the first transmission and processing time period is longer than a predetermined feedback delay, the centralized computation center sends second instruction information and/or scheduling information of uplink data to a local computation center.

The second instruction information is used to instruct the local computation center to perform virtual feedback on the uplink data.

At 603, the local computation center receives the second instruction information and/or the scheduling information of the uplink data sent by the centralized computation center.

At 604, before obtaining a decoding result of the uplink data, the local computation center sends virtual feedback information of the uplink data and/or scheduling information of the uplink data to an RRU.

The virtual feedback information of the uplink data may be generated by the local computation center.

At 605, the RRU receives the virtual feedback information of the uplink data and/or the scheduling information of the uplink data sent by the local computation center.

At 606, the RRU sends the virtual feedback information of the uplink data and/or the scheduling information of the uplink data to a user terminal in a predetermined subframe.

At 607, the user terminal receives the virtual feedback information of the uplink data and/or the scheduling information of the uplink data in a predetermined subframe.

At 608, the user terminal performs physical layer processing on data to be retransmitted and/or new data based on the virtual feedback information of the uplink data and/or the scheduling information of the uplink data at a predetermined time instant.

It should be noted that, in a case that the first transmission and processing time period is shorter than or equal to a predetermined feedback delay, step 609 may be directly performed without performing step 602 to 608, i.e., performing normal feedback flow.

At 609, after obtaining the decoding result of the uplink data, the local computation center sends true feedback information of the uplink data to the RRU.

At 610, the RRU sends the true feedback information of the uplink data to the user terminal.

At 611, the user terminal receives the true feedback information of the uplink data.

At 612, the user terminal performs retransmission and/or new data transmission based on the true feedback information of the uplink data.

In the C-RAN architecture shown in FIG. 1B, in a case that the physical layer processing such as downlink modulating and encoding is performed by the local computation center, the virtual feedback information may be generated by the local computation center and sent to the RRU as described in the embodiment.

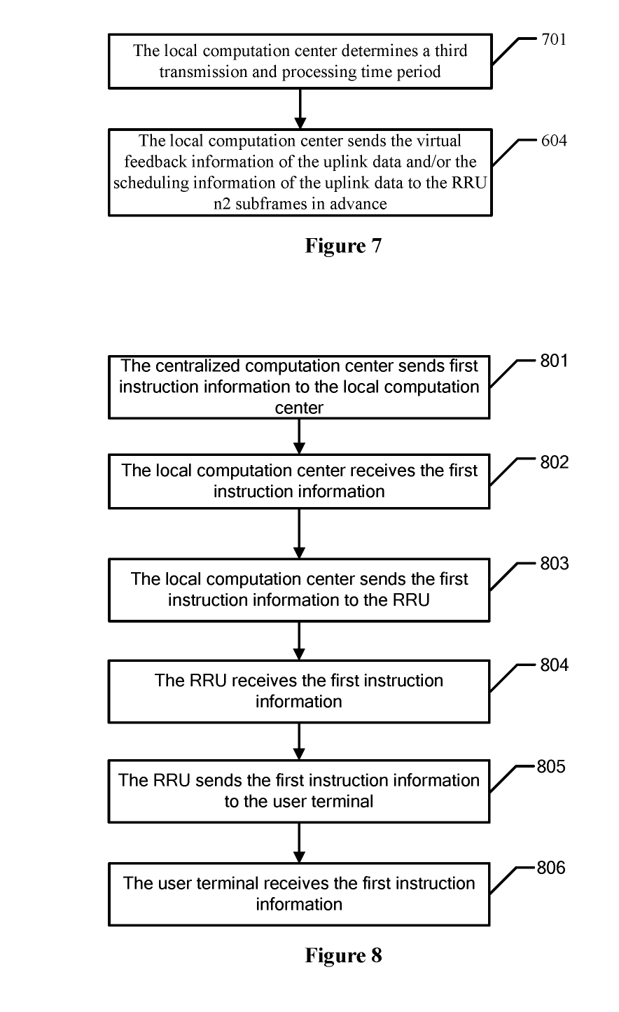

Preferably, as shown in FIG. 7, before step 604, the method may include:

at 701, the local computation center determines a third transmission and processing time period, where the third transmission and processing time period may include a transmission and processing time period from a time instant when the local computation center starts to send downlink subframe data to a time instant when the RRU sends the downlink subframe data.

Preferably, step 604 may include: the local computation center sends downlink subframe data containing the virtual feedback information of the uplink data and/or the scheduling information of the uplink data to the RRU n2 subframes in advance.

Time duration of the n2 subframes is longer than or equal to the third transmission and processing time period. For example, in a case that the third transmission and processing time period is 1.7 ms and the time duration of one subframe is 1 ms, the value of n2 may be 2.

As shown in FIG. 3B, the third transmission and processing time period may include a transmission time period m9 for transmitting the downlink subframe data (containing the virtual feedback information of the uplink data and/or the scheduling information of the uplink data) from the local computation center to the RRU and a processing time period m10 for processing it in the RRU.

Preferably, the second instruction information may include a subframe number or a process number corresponding to the virtual feedback information.

In the embodiment, in step 604, the local computation center sending the virtual feedback information of the uplink data and/or the scheduling information of the uplink data to the RRU may include the following three cases.

1. The local computation center sends the virtual feedback information of the uplink data and the scheduling information of the uplink data to the RRU, and thus, in step 608 the user terminal needs to start physical layer processing on data to be retransmitted and new data at the same time based on the virtual feedback information and the scheduling information of the uplink data at a predetermined time instant, and in step 612 the user terminal retransmits the uplink data or transmits new data.

2. The local computation center sends the virtual feedback information of the uplink data to the RRU without sending scheduling information of the uplink data, and thus, in step 608, the user terminal only needs to start physical layer processing on the data to be retransmitted based on the virtual feedback information at a predetermined time instant, and in step 612 the user terminal performs retransmission.

3. The local computation center sends the scheduling information of the uplink data to the RRU without sending virtual feedback information of the uplink data, and thus, in step 608, the user terminal needs to start physical layer processing on the new data based on the scheduling information of the uplink data at a predetermined time instant, and may also starts physical layer processing on the data to be retransmitted simultaneously, and in step 612 the user terminal performs retransmission or new data transmission.

Preferably, for cases 1 and 2, in order to facilitate the user terminal to distinguish the virtual feedback information and the true feedback information, the virtual feedback information may include an identifier for identifying the virtual feedback information, and the true feedback information may include an identifier for identifying the true feedback information. Specifically, one identifier bit may be added in the feedback information to indicate whether the feedback information is virtual or true. For example, 0 identifies the virtual feedback information and 1 identifies the true feedback information. Practically the manner for identifying is not limited thereto, and those skilled in the art may select other manner for identifying as needed.

Preferably, for case 3, before step 604, the method may further include the following steps, as shown in FIG. 8.

At 801, the centralized computation center sends first instruction information to the local computation center, and the first instruction information is used to instruct the user terminal to start physical layer processing on data to be retransmitted (or data to be retransmitted and new data) at a predetermined time instant.

At 802, the local computation center receives the first instruction information.

At 803, the local computation center sends the first instruction information to the RRU.

At 804, the RRU receives the first instruction information.

At 805, the RRU sends the first instruction information to the user terminal.

At 806, the user terminal receives the first instruction information.

Since the user terminal receives the first instruction information in advance, in step 604 the local computation center may send no virtual feedback information to improve wireless transmission efficiency. This is because the user terminal may also start physical layer processing on the data to be retransmitted based on the first instruction information at a predetermined time instant in step 608, even if the user terminal receives no virtual feedback information.

Specifically, the first instruction information may include a process number or a corresponding subframe number for physical layer processing performed on data to be retransmitted and new data, which is started by the user terminal at the predetermined time instant.

Preferably, the centralized computation center may send the first instruction information to the UE associated with the RRU by broadcasting, and practically those skilled in the art may use other ways for sending as needed, which is not limited here.

The feedback method for an uplink hybrid automatic repeat request provided in the embodiment is applied to a scene that some of baseband processing tasks and feedback for the uplink data are performed by the local computation center. In the embodiment, in a case that the first transmission time period is longer than the predetermined delay, the downlink subframe data containing the virtual feedback information and/or the scheduling information of the uplink data is sent n2 subframes in advance, such that the UE performs physical layer processing on data to be retransmitted and/or new data at a time instant stipulated in the conventional protocol and the extra transmission delay caused by the transport network can be compensated, and thereby maintaining Round Trip Time RTT of one process, ensuring the performance of a user service and ensuring data throughput of the user terminal.

### Fourth Embodiment

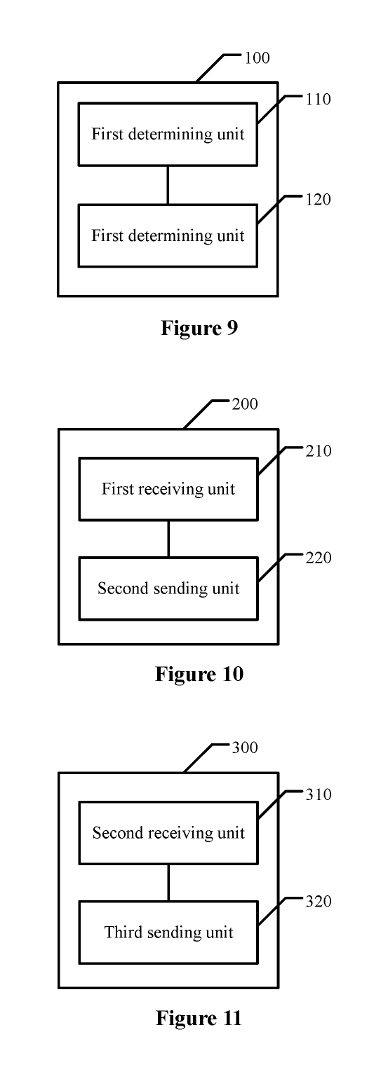

According to the present disclosure, a centralized computation center 100 is provided. As shown in FIG. 9, the centralized computation center 100 is as follows.

A first determining unit 110 is configured to determine a first transmission and processing time period, where the transmission and processing time period includes a transmission and processing time period from a time instant when uplink data is received by a remote radio unit RRU to a time instant when the RRU sends feedback information of the uplink data.

The definition of the first transmission and processing time period may be referred to the description in the first embodiment or the second embodiment, which is not described detailed here.

A first sending unit 120 is configured to send, in a case that the first transmission and processing time period is longer than a predetermined feedback delay and before a decoding result of the uplink data is obtained, virtual feedback information of the uplink data and/or scheduling information of the uplink data to the RRU, which in turn sends the virtual feedback information and/or the scheduling information of the uplink data to a user terminal in a predetermined subframe.

The definition of the predetermined feedback delay may be referred to the description in the first embodiment or the second embodiment, which is not described detailed here.

Furthermore, the centralized computation center 100 may further include:

a second determining unit configured to determine a second transmission and processing time period.

The definition of the second transmission and processing time period may be referred to the description in the second embodiment, which is not described detailed here.

The first sending unit 120 is specifically configured to send the virtual feedback information to the RRU n1 subframes in advance, where time duration of the n1 subframes is longer than or equal to the second transmission and processing time period.

Preferably, the first sending unit 120 may be further configured to send, before sending the virtual feedback information of the uplink data and/or the scheduling information of the uplink data, first instruction information to the RRU, which in turn sends the first instruction information to the user terminal. The first instruction information is used to instruct the user terminal to start physical layer processing on data to be retransmitted and/or new data at a predetermined time instant.

Preferably, the first sending unit 120 may be further configured to send, in a case that the centralized computation center obtains the decoding result of the uplink data, true feedback information of the uplink data to the RRU, which in turn sends the true feedback information to the user terminal.

Furthermore, the centralized computation center 100 may further include:

an off-line planning unit configured to determine the first transmission and processing time period and/or the second transmission and processing time period by planning in an off-line manner; or

a real-time measuring unit configured to determine the first transmission and processing time period and/or the second transmission and processing time period by measuring in a real time manner.

In a case that the centralized computation center according to the embodiment can not perform feedback on the uplink data based on a stipulation in the conventional protocol, the centralized computation center sends the virtual feedback information and/or the scheduling information of the uplink data to the user terminal in advance, such that the user terminal can prepare the uplink transmission data based on the virtual feedback information and/or the scheduling information of the uplink data at a time instant stipulated in the conventional protocol, and thereby avoiding increasing HARQ RTT and improving the service performance.

### Fifth Embodiment

According to the present disclosure, a remote radio unit 200 is provided. As shown in FIG. 10, the remote radio unit (RRU) 200 includes the following units.

A first receiving unit 210 is configured to receive virtual feedback information of uplink data and/or scheduling information of the uplink data which is sent by a centralized computation center 100 or a local computation center 300, where the virtual feedback information and/or the scheduling information of the uplink data is sent, in a case that a first transmission and processing time period is longer than a predetermined feedback delay, to the RRU 200 by the centralized computation center 100 or the local computation center 300 before a decoding result of the uplink data is obtained.

The definition of the first transmission and processing time period may be referred to the description in the first embodiment or the second embodiment, which is not described detailed here.

A second sending unit 220 is configured to send the virtual feedback information and/or the scheduling information of the uplink data to a user terminal in a predetermined subframe.

Preferably, the first receiving unit 210 may be further configured to receive first instruction information sent by the centralized computation center 100, and the first instruction information is used to instruct the user terminal to start physical layer processing on data to be retransmitted and/or new data at a predetermined time instant.

Accordingly, the second sending unit 220 may be further configured to send the first instruction information to the user terminal.

Preferably, the virtual feedback information and/or the scheduling information of the uplink data may be sent to the RRU 200 by the centralized computation center 100 n1 subframes in advance, or may be sent to the RRU 200 by the local computation center 300 n2 subframes in advance. The time duration of the n1 subframes is longer than or equal to the second transmission and processing time period, and the time duration of the n2 subframes is longer than or equal to a third transmission and processing time period.

The definition of the second transmission and processing time period or the third transmission and processing time period may be referred to the description in the second embodiment or the third embodiment, which is not described detailed here.

Preferably, the first receiving unit 210 may be further configured to receive true feedback information of the uplink data sent by the centralized computation center 100 or the local computation center 300 after the decoding result of the uplink data is obtained.

Accordingly, the second sending unit 220 may be further configured to send the true feedback information to the user terminal.

### Sixth Embodiment

According to the present disclosure, a local computation center 300 is provided. As shown in FIG. 11, the local computation center may include the following units.

A second receiving unit 310 is configured to receive second instruction information sent by a centralized computation center 100 and used to instruct to perform virtual feedback on uplink data, where the second instruction information is sent to the local computation center 300 by the centralized computation center 100 in a case that a first transmission and processing time period is longer than a predetermined feedback delay.

The definition of the first transmission and processing time period may be referred to the description in the first embodiment or the second embodiment, which is not described detailed here.

In the C-RAN architecture shown in FIG. 1B, in a case that physical layer processing, for example downlink modulation and encoding, is performed by the local computation center, virtual feedback information may be generated by the local computation center and sent to an RRU.

The third sending unit 320 is configured to send, based on the second instruction information and before a decoding result of the uplink data is obtained, virtual feedback information of the uplink data and/or scheduling information of the uplink data to the RRU 200, which in turn sends the virtual feedback information and/or the scheduling information of the uplink data to a user terminal in a predetermined subframe.

Preferably, the second receiving unit 310 may be further configured to receive first instruction information sent by the centralized computation center, where the first instruction information is used to instruct the user terminal to start physical layer processing on data to be retransmitted and/or new data at a predetermined time instant.

Accordingly, the third sending unit 320 may be further configured to send the first instruction information to the RRU 200.

Preferably, the local computation center 300 may further include:

a third determining unit configured to determine a third transmission and processing time period. The definition of the third transmission and processing time period may be referred to the description in the third embodiment, which is not described detailed here.

Preferably, the virtual feedback information and/or the scheduling information of the uplink data may be sent to the RRU 200 by the local computation center 300 n2 subframes in advance. The time duration of the n2 subframes is longer than or equal to the third transmission and processing time period.

Preferably, the third sending unit 320 may be further configured to send, after a decoding result of the uplink data is obtained, true feedback information of the uplink data to the RRU 200, which in turn sends the true feedback information to the user terminal.

### Seventh Embodiment

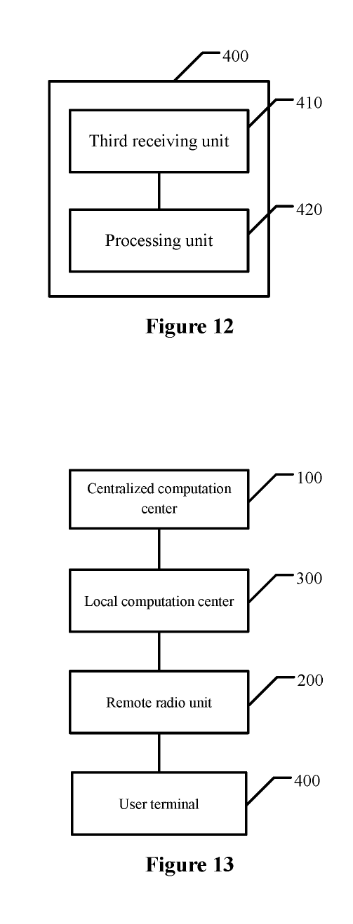

According to the present disclosure, a user terminal 400 is provided. As shown in. FIG. 12, the user terminal 400 may include the following units.

A third receiving unit 410 is configured to receive virtual feedback information of uplink data and/or scheduling information of the uplink data sent by an RRU 200 in a predetermined subframe, where the virtual feedback information of the uplink data and/or the scheduling information of the uplink data is sent, in a case that a first transmission and processing time period is longer than a predetermined feedback delay, to the RRU 200 by a centralized computation center 100 or a local computation center 300 before a decoding result of the uplink data is obtained.

The definition of the first transmission and processing time period may be referred to the description in the first embodiment or the second embodiment, which is not described detailed here.

A processing unit 420 is configured to start physical layer processing on data to be retransmitted and/or new data, based on the virtual feedback information of the uplink data and/or the scheduling information of the uplink data, at a predetermined time instant.

Preferably, the third receiving unit 410 may be further configured to receive first instruction information sent by the RRU 200.

Specifically, the first instruction information may be used to instruct the user terminal 400 to start physical layer processing on data to be retransmitted and/or new data at a predetermined time instant.

Preferably, the virtual feedback information of the uplink data and/or the scheduling information of the uplink data received by the third receiving unit 410 is sent, in a case that the first transmission and processing time period is longer than a predetermined feedback delay, to the RRU 200 by the centralized computation center 100 n1 subframes in advance or to the RRU 200 by the local computation center 300 n2 subframes in advance.

Specifically, the time duration of the n1 subframes is longer than or equal to the second transmission and processing time period, and the time duration of the n2 subframes is longer than or equal to a third transmission and processing time period. The definition of the second transmission and processing time period may be referred to the description in the first embodiment or the second embodiment, and the definition of the third transmission and processing time period may be referred to the description in the third embodiment, which is not described detailed here.

### Eighth Embodiment

According to the present disclosure, a feedback system for an uplink hybrid automatic repeat request is provided. As shown in FIG. 13, the system includes:

the centralized computation center 100 described in the fourth embodiment, and the RRU 200 described in the fifth embodiment, and/or the local computation center 300 described in the sixth embodiment and/or the user terminal 400 described in the seventh embodiment.

Corresponding contents may be referred to the description in the above embodiments, which is not described detailed here.

Hereinafter a feedback method and feedback system for an uplink hybrid automatic repeat request and a related device according to the present disclosure are described by specific examples.

It is assumed that an extra transmission delay caused by the transport network is 2 ms, including 1.5 ms for uplink data transmission and 0.5 ms for downlink ACK/NACK feedback transmission; and a processing time period is longer than 2 ms and shorter than 4 ms, i.e., a total transmission and processing time period T1 is between 4 ms and 6 ms.

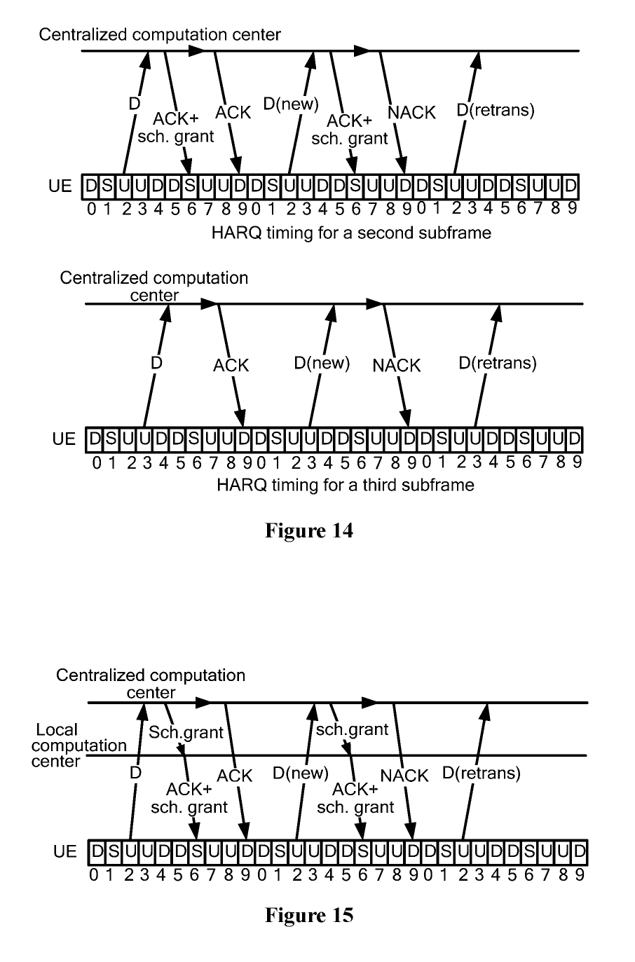

Under a scene for TDD DL:UL=2:2 (TDD uplink and downlink configuration 1), for a second subframe, n=4, ACK/NACK can not be fed back at a predetermined time instant, i.e., 4 ms after uplink transmission (a sixth subframe); and in this case, the centralized computation center instructs to feed back a virtual ACK and a true ACK/NACK for uplink transmission process corresponding to the second subframe for all the UEs connected to the RRU, simultaneously. As shown in FIG. 14, virtual feedback information and scheduling information of uplink data (ACk+sch.grant) are transmitted in the sixth subframe before a decoding result of the uplink data is obtained, and true feedback information (ACK) is fed back in a ninth subframe after the decoding result of the uplink data is obtained. In the Figure, D (new) represents uplink new data and D (retans) represents data to be retransmitted.

For a third subframe, n=6, i.e., in a case that the first transmission and processing time period is shorter than a predetermined feedback delay, the extra transmission delay may be compensated, and the uplink transmission for the third subframe is performed using the standard post-decoding feedback mode. FIG. 14 describes feedback timing of virtual ACK and true ACK/NACK for HARQ processes corresponding to the second subframe and the third subframe.

As shown in FIG. 14, feedback information for both the second uplink subframe and the third uplink subframe is transmitted in the ninth subframe simultaneously, and hence a corresponding process number needs to be marked for the information of each feedback.

In the C-RAN architecture shown in FIG. 1B, in a case that physical layer processing, for example downlink modulation and encoding, is performed by the local computation center, the virtual feedback information may be generated by the local computation center and sent to the RRU. As shown in FIG. 15, for the second subframe, the centralized computation center sends instruction information to the local computation center for performing virtual feedback, and the local computation center generates virtual feedback information before a decoding result of the uplink data is obtained; downlink subframe data is generated based on the virtual feedback information and scheduling information of the uplink data received from the centralized computation center (Ack+sch.grant), and is sent to the UE via the RRU in the sixth subframe stipulated based on the conventional protocol. The true feedback information (ACK) is sent in the ninth subframe.

### Ninth Embodiment

According to the present disclosure, a computer storage medium is provided. Programs may be stored in the computer storage medium and all or a part of steps of the feedback method for an uplink hybrid automatic repeat request described in the first embodiment, the second embodiment or the third embodiment are performed when the programs are executed. Specific contents may be referred to the description in the first embodiment to the third embodiment, which is not described detailed here.

### Tenth Embodiment

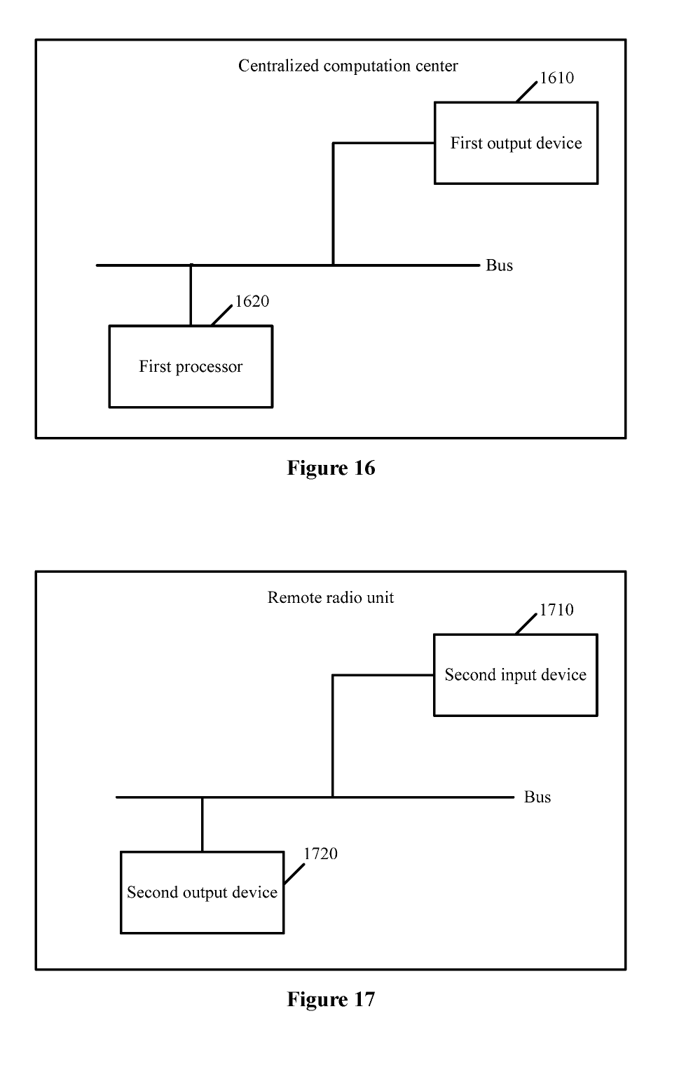

As shown in FIG. 16, a centralized computation center is provided according to the present disclosure. The centralized computation center may include a first output device 1610 and a first processor 1620 (the centralized computation center may include one or more processors, and one processor is shown in FIG. 16 as an example). In some embodiments of the present disclosure, the first output device 1610 may be connected to the first processor 1620 by a bus or using other ways, and bus connection is shown in FIG. 16 as a example.

The first processor 1620 may be configured to determine a first transmission and processing time period, and the first transmission and processing time period includes a transmission and processing time period from a time instant when uplink data is received by an RRU to a time instant when the RRU sends feedback information of the uplink data.

The first output device 1610 may be configured to send, in a case that the first transmission and processing time period is longer than a predetermined feedback delay and before a decoding result of the uplink data is obtained, virtual feedback information of the uplink data and/or scheduling information of the uplink data to the RRU, which in turn sends the virtual feedback information of the uplink data and/or the scheduling information of the uplink data to a user terminal in a predetermined subframe.

Preferably, the first output device 1610 may be configured to send first instruction information to the RRU, which in turn sends the first instruction information to the user terminal, and the first instruction information is used to instruct the user terminal to start physical layer processing on data to be retransmitted and/or new data at a predetermined time instant.

Preferably, the first processor 1620 may be further configured to determine a second transmission and processing time period, where the second transmission and processing time period includes a transmission and processing time period from a time instant when the centralized computation center starts to send downlink subframe data to a time instant when the RRU sends the downlink subframe data, or the second transmission and processing time period includes a transmission and processing time period from a time instant when the centralized computation center starts to send virtual feedback information of the uplink data and/or the scheduling information of the uplink data to a time instant when the RRU sends downlink subframe data containing the virtual feedback information of the uplink data and/or the scheduling information of the uplink data.

The first output device 1610 is specifically configured to send the virtual feedback information of the uplink data and/or the scheduling information of the uplink data to the RRU n1 sbuframes in advance. The time duration of the n1 subframes is longer than or equal to the second transmission and processing time period.

Preferably, the first output device 1610 is further configured to send true feedback information of the uplink data to the RRU, which in turn sends the true feedback information to the user terminal.

Preferably, the virtual feedback information includes an identifier for identifying the virtual feedback information, and the true feedback information includes an identifier for identifying the true feedback information.

### Eleventh Embodiment

As shown in FIG. 17, a remote radio unit is further provided according to the present disclosure. The remote radio unit may include a second input device 1710 and a second output device 1720. In some embodiments of the present disclosure, the second input device 1710 may be connected to the second output device 1720 by a bus or using other ways, and bus connection is shown in FIG. 17 as a example.

The second input device 1710 is configured to receive virtual feedback information of the uplink data and/or scheduling information of the uplink data sent by a centralized computation center or a local computation center, where the virtual feedback information of the uplink data and/or the scheduling information of the uplink data is sent, in a case that a first transmission and processing time period is longer than a predetermined feedback delay, to the remote radio unit RRU by the centralized computation center or the local computation center before a decoding result of the uplink data is obtained; and the first transmission and processing time period includes a transmission processing time period from a time instant when the uplink data is received by the RRU to a time instant when the RRU sends feedback information of the uplink data.

The second output device 1720 is configured to send the virtual feedback information of the uplink data and/or the scheduling information of the uplink data to a user terminal in a predetermined subframe.

Preferably, the second input device 1710 may be further configured to receive first instruction information sent by the centralized computation center, and the first instruction information is used to instruct the user terminal to start physical layer processing on data to be retransmitted and/or new data at a predetermined time instant.

The second output device 1720 is further configured to send the first instruction information to the user terminal.

Preferably, the virtual feedback information of the uplink data and/or the scheduling information of the uplink data is sent, in a case that the first transmission and processing time period is longer than the predetermined feedback delay, to the RRU by the centralized computation center n1 subframes in advance or to the RRU by the local computation center n2 subframes in advance. The time duration of the n1 subframes is longer than or equal to the second transmission and processing time period. The second transmission and processing time period includes a transmission and processing time period from a time instant when the centralized computation center starts to send downlink subframe data to a time instant when the RRU sends the downlink subframe data, or the second transmission and processing time period includes a transmission and processing time period from a time instant when the centralized computation center starts to send the first instruction information to a time instant when the RRU sends downlink subframe data containing the first instruction information. The time duration of the n2 subframes is longer than or equal to the third transmission and processing time period. The third transmission and processing time period includes a transmission and processing time period from a time instant when the local computation center starts to send downlink subframe data to a time instant when the RRU sends the downlink subframe data.

Preferably, the second input device 1710 is further configured to receive true feedback information of the uplink data sent by the centralized computation center or the local computation center after a decoding result of the uplink data is obtained.

The second output device 1720 is further configured to send the true feedback information to the user terminal.

Preferably, the virtual feedback information includes an identifier for identifying the virtual feedback information, and the true feedback information includes an identifier for identifying the true feedback information.

### Twelfth Embodiment

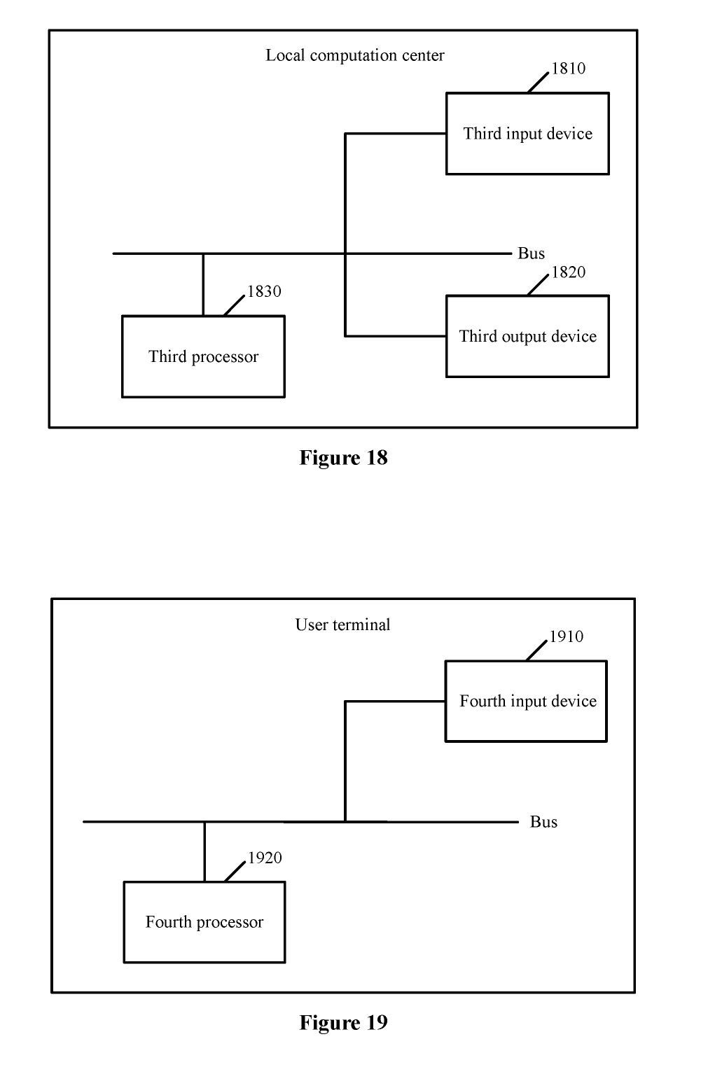

As shown in FIG. 18, a local computation center is provided according to the present disclosure. The local computation center may include a third input device 1810 and a third output device 1820. In some embodiments of the present disclosure, the third input device 1810 may be connected to the third output device 1820 by a bus or using other ways, and bus connection is shown in FIG. 18 as a example.

The third input device 1810 is configured to receive second instruction information for instructing to perform virtual feedback on uplink data and/or scheduling information of the uplink data, sent by a centralized computation center. The second instruction information is sent to the local computation center by the centralized computation center, in a case that a first transmission and processing time period is longer than a predetermined feedback delay; and the first transmission and processing time period includes a transmission and processing time period from a time instant when the uplink data is received by the RRU to a time instant when the RRU sends feedback information of the uplink data.

The third output device 1820 sends, before a decoding result of the uplink data is obtained, the virtual feedback information of the uplink data and/or the scheduling information of the uplink data to the RRU, which in turn sends the virtual feedback information of the uplink data and/or the scheduling information of the uplink data to a user terminal in a predetermined subframe.

Preferably, the third input device 1810 is further configured to receive first instruction information sent by the centralized computation center, and the first instruction information is used to instruct the user terminal to start physical layer processing on data to be retransmitted and/or new data at a predetermined time instant.

The third output device 1820 is further configured to send the first instruction information to the RRU, which in turn sends the first instruction information to the user terminal.

Preferably, as shown in FIG. 18, the local computation center may further include a third processor 1830 (the local computation center may include one or more processor, and one processor is shown in FIG. 18 as an example). The third processor 1830 is configured to determine a third transmission and processing time period, and the third transmission and processing time period includes a transmission and processing time period from a time instant when the local computation center starts to send downlink subframe data to a time instant when the RRU sends the downlink subframe data.

The third output device 1820 is specifically configured to send the virtual feedback information and/or the scheduling information of the uplink data to the RRU n2 subframes in advance. The time duration of the n2 subframes is longer than or equal to the third transmission and processing time period.

Preferably, the third output device 1820 is further configured to send true feedback information of the uplink data to the RRU, which in turn sends the true feedback information to the user terminal.

Preferably, the virtual feedback information includes an identifier for identifying the virtual feedback information, and the true feedback information includes an identifier for identifying the true feedback information.

### Thirteenth Embodiment

As shown in FIG. 19, a user terminal is provided according to the present disclosure. The user terminal may include a fourth input device 1910 and a fourth processor 1920 (the user terminal may include one or more processors, and in FIG. 19 one processor is shown as an example). In some embodiments of the present disclosure, the fourth input device 1910 may be connected to the fourth processor 1920 by a bus or using other ways, and bus connection is shown in FIG. 19 as a example.

The fourth input device 1910 is configured to receive virtual feedback information of uplink data and/or scheduling information of the uplink data sent by a remote radio unit RRU in a predetermined subframe. The virtual feedback information of the uplink data and/or the scheduling information of the uplink data is sent, in a case that a first transmission and processing time period is longer than a predetermined feedback delay, to the RRU by a centralized computation center or a local computation center before a decoding result of the uplink data is obtained. The first transmission and processing time period includes a transmission and processing time period from a time instant when the uplink data is received by the RRU to a time instant when the RRU sends feedback information of the uplink data.

The fourth processor 1920 is configured to start physical layer processing on data to be retransmitted and/or new data based on the virtual feedback information of the uplink data and/or the scheduling information of the uplink data at a predetermined time instant.

Preferably, the fourth input device 1910 is further configured to receive first instruction information sent by the RRU, and the first instruction information is used to instruct a user terminal to start physical layer processing on data to be retransmitted and/or new data at a predetermined time instant.

Preferably, the virtual feedback information of the uplink data and/or the scheduling information of the uplink data is sent, in a case that the first transmission and processing time period is longer than a predetermined feedback delay, to the RRU by the centralized computation center n1 subframes in advance or to the RRU by the local computation center n2 subframes in advance.

The time duration of the n1 subframes is longer than or equal to the second transmission and processing time period. The second transmission and processing time period includes a transmission and processing time period from a time instant when the centralized computation center or the local computation center starts to send downlink subframe data to a time instant when the RRU sends the downlink subframe data; or the second transmission and processing time period includes a transmission and processing time period from a time instant when the centralized computation center or the local computation center starts to send the virtual feedback information of the uplink data and/or the scheduling information of the uplink data to a time instant when the RRU sends downlink subframe data containing the virtual feedback information of the uplink data and/or the scheduling information of the uplink data.

The time duration of the n2 subframes is longer than or equal to a third transmission and processing time period; and the third transmission and processing time period includes a transmission and processing time period from a time instant when the local computation center starts to send downlink subframe data to a time instant when the RRU sends the downlink subframe data.

Preferably, the fourth input device 1910 is further configured to receive true feedback information of the uplink data sent by the RRU; and the true feedback information of the uplink data is sent to the RRU by the centralized computation center or the local computation center after the decoding result of the uplink data is obtained.

The fourth processor 1920 is further configured to perform retransmission or new data transmission based on the true feedback information of the uplink data.

Preferably, the virtual feedback information includes an identifier for identifying the virtual feedback information, and the true feedback information includes an identifier for identifying the true feedback information.

The feedback method and feedback system for an uplink hybrid automatic repeat request and a related device according to the present disclosure are described above. Respective embodiments lay emphasis on different aspects, and a content of a certain embodiment which is not described in detail may be referred to the description in other embodiments.

Those skilled in the art should understand that all of or a part of steps of the methods according to the above embodiments may be performed by related hardware instructed by programs. The programs may be stored in a computer readable storage medium, for example a flash storage disk, a Read-Only Memory (ROM), a Random Access Memory (RAM), a magnetic disk or an optical disk.

The feedback method and feedback system for an uplink hybrid automatic repeat request and a related device according to the embodiments of the present disclosure are described in detail above. Principles and implementations of the present disclosure are clarified using specific examples herein, and the description of the embodiments is only to assist understanding the method of the present disclosure and a key concept thereof. In addition, those skilled in the art may make changes to the specific implementations and the application range according to the concept of the present disclosure. In summary, the content of the specification is not intended to limit the present disclosure.

What is claimed is:

1. A feedback method for an uplink hybrid automatic repeat request, comprising:
determining a first transmission and processing time period, wherein the first transmission and processing time period comprises a transmission and processing time period from a time when uplink data is received by a remote radio unit (RRU) to a time when the RRU sends feedback information of the uplink data; and
sending, in response to determining that the first transmission and processing time period is longer than a predetermined feedback delay and before a decoding result of the uplink data is obtained, at least one of virtual feedback information of the uplink data and scheduling information of the uplink data to the RRU, which in turn sends the at least one of the virtual feedback information of the uplink data and the scheduling information of the uplink data to a user terminal in a predetermined subframe.

2. The method according to claim 1, wherein before the sending the at least one of the virtual feedback information of the uplink data and the scheduling information of the uplink data to the RRU, the method further comprises:
sending first instruction information to the RRU, which in turn sends the first instruction information to the user terminal, wherein the first instruction information instructs the user terminal to start physical layer processing on at least one of data to be retransmitted and new data at a predetermined time.

3. The method according to claim 1, further comprising:
determining a second transmission and processing time period, wherein the second transmission and processing time period comprises a transmission and processing time period from a time when a centralized computation center starts to send downlink subframe data to a time when the RRU sends the downlink subframe data, or the second transmission and processing time period comprises a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data;
wherein the sending virtual feedback information of the uplink data and/or scheduling information of the uplink data to the RRU before a decoding result of the uplink data is obtained comprises:
sending the virtual feedback information of the uplink data and/or the scheduling information of the uplink data to the RRU n1 subframes in advance, wherein a time duration of the n1 subframes is longer than or equal to the second transmission and processing time period.

4. The method according to claim 3, further comprising:
sending, after the decoding result of the uplink data is obtained, true feedback information of the uplink data to the RRU, which in turn sends the true feedback information to the user terminal.

5. The method according to claim 4, wherein the virtual feedback information comprises an identifier for identifying the virtual feedback information, and the true feedback information comprises an identifier for identifying the true feedback information.

6. The method according to claim 2, further comprising:
determining a second transmission and processing time period, wherein the second transmission and processing time period comprises a transmission and processing time period from a time when a centralized computation center starts to send downlink subframe data to a time when the RRU sends the downlink subframe data, or the second transmission and processing time period comprises a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data;
wherein the sending virtual feedback information of the uplink data and/or scheduling information of the uplink data to the RRU before a decoding result of the uplink data is obtained comprises:
sending the virtual feedback information of the uplink data and/or the scheduling information of the uplink data to the RRU n1 subframes in advance, wherein a time duration of the n1 subframes is longer than or equal to the second transmission and processing time period.

7. The method according to claim 6, further comprising:
sending, after the decoding result of the uplink data is obtained, true feedback information of the uplink data to the RRU, which in turn sends the true feedback information to the user terminal.

8. The method according to claim 7, wherein the virtual feedback information comprises an identifier for identifying the virtual feedback information, and the true feedback information comprises an identifier for identifying the true feedback information.

9. A feedback method for an uplink hybrid automatic repeat request, comprising:
receiving second instruction information for instructing to perform virtual feedback on uplink data and/or scheduling information of the uplink data sent by a centralized computation center, wherein the second instruction information is sent to a local computation center by the centralized computation center in a case that a first transmission and processing time period is longer than a predetermined feedback delay, and the first transmission and processing time period comprises a transmission and processing time period from a time when the uplink data is received by a remote radio unit (RRU) to a time when the RRU sends feedback information of the uplink data; and
sending, before a decoding result of the uplink data is obtained, at least one of virtual feedback information of the uplink data and the scheduling information of the uplink data to the RRU, which in turn sends the at least one of the virtual feedback information of the uplink data and the scheduling information of the uplink data to a user terminal in a predetermined subframe.

10. The method according to claim 9, wherein before the receiving second instruction information for instructing to perform virtual feedback on uplink data and/or scheduling information of the uplink data sent by a centralized computation center, the method further comprises:
receiving first instruction information sent by the centralized computation center, wherein the first instruction information instructs the user terminal to start physical layer processing on data to be retransmitted and/or new data at a predetermined time; and
sending the first instruction information to the RRU, which in turn sends the first instruction information to the user terminal.

11. The method according to claim 9, further comprising:
determining a third transmission and processing time period, wherein the third transmission and processing time period comprises a transmission and processing time period from a time when the local computation center starts to send downlink subframe data to a time when the RRU sends the downlink subframe data;
wherein the sending, before a decoding result of the uplink data is obtained, virtual feedback information of the uplink data and/or the scheduling information of the uplink data to the RRU comprises:
sending the virtual feedback information and/or the scheduling information of the uplink data to the RRU n2 subframes in advance, wherein a time duration of the n2 subframes is longer than or equal to the third transmission and processing time period.

12. The method according to claim 11, further comprising:
sending, after the decoding result of the uplink data is obtained, true feedback information of the uplink data to the RRU, which in turn sends the true feedback information to the user terminal.

13. The method according to claim 12, wherein the virtual feedback information comprises an identifier for identifying the virtual feedback information, and the true feedback information comprises an identifier for identifying the true feedback information.

14. The method according to claim 10, further comprising:
determining a third transmission and processing time period, wherein the third transmission and processing time period comprises a transmission and processing time period from a time when the local computation center starts to send downlink subframe data to a time when the RRU sends the downlink subframe data;
wherein the sending, before a decoding result of the uplink data is obtained, virtual feedback information of the uplink data and/or the scheduling information of the uplink data to the RRU comprises:
sending the virtual feedback information and/or the scheduling information of the uplink data to the RRU n2 subframes in advance, wherein a time duration of the n2 subframes is longer than or equal to the third transmission and processing time period.

15. The method according to claim 14, further comprising:
sending, after the decoding result of the uplink data is obtained, true feedback information of the uplink data to the RRU, which in turn sends the true feedback information to the user terminal.

16. The method according to claim 15, wherein the virtual feedback information comprises an identifier for identifying the virtual feedback information, and the true feedback information comprises an identifier for identifying the true feedback information.

17. A centralized computation center, comprising a first output device and a first processor, wherein:
the first processor is configured to determine a first transmission and processing time period, wherein the first transmission and processing time period comprises a transmission and processing time period from a time when uplink data is received by a remote radio unit (RRU) to a time when the RRU sends feedback information of the uplink data; and
the first output device is configured to send, in response to determining that the first transmission and processing time period is longer than a predetermined feedback delay and before a decoding result of the uplink data is obtained, at least one of virtual feedback information of the uplink data and scheduling information of the uplink data to the RRU, which in turn sends the at least one of the virtual feedback information of the uplink data and the scheduling information of the uplink data to a user terminal in a predetermined subframe.

18. The centralized computation center according to claim 17, wherein the first output device is further configured to send first instruction information to the RRU, which in turn sends the first instruction information to the user terminal, wherein the first instruction information is used to instruct the user terminal to start physical layer processing on data to be retransmitted and/or new data at a predetermined time.

19. The centralized computation center according to claim 17, wherein:
the first processor is further configured to determine a second transmission and processing time period, wherein the second transmission and processing time period comprises a transmission and processing time period from a time when the centralized computation center starts to send downlink subframe data to a time when the RRU sends the downlink subframe data, or the second transmission and processing time period comprises a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data; and
the first output device is configured to send the virtual feedback information of the uplink data and/or the scheduling information of the uplink data to the RRU n1 subframes in advance, and a time duration of the n1 subframes is longer than or equal to the second transmission and processing time period.

20. The centralized computation center according to claim 18, wherein:
the first processor is further configured to determine a second transmission and processing time period, wherein the second transmission and processing time period comprises a transmission and processing time period from a time when the centralized computation center starts to send downlink subframe data to a time when the RRU sends the downlink subframe data, or the second transmission and processing time period comprises a transmission and processing time period from a time when the centralized computation center starts to send the virtual feedback information of the uplink data and/or the scheduling information of the uplink data to a time when the RRU sends downlink subframe data containing the virtual feedback information of the uplink data and/or the scheduling information of the uplink data; and
the first output device is configured to send the virtual feedback information of the uplink data and/or the scheduling information of the uplink data to the RRU n1 subframes in advance, and a time duration of the n1 subframes is longer than or equal to the second transmission and processing time period.
